(19) United States
(12) Patent Application Publication
(10) Pub. No.: US 2005/0196069 A1
(43) Pub. Date: Sep. 8, 2005

(54) Method, apparatus, and program for trimming images

(75) Inventor: Makoto Yonaha, Kanagawa-ken (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/066,436

(22) Filed: Feb. 28, 2005

(30) Foreign Application Priority Data
Mar. 1, 2004 (JP) 056131/2004

(51) Int. Cl. G06K 9/20

(52) U.S. Cl. 382/282

(57) ABSTRACT

Trimming processes are efficiently performed on images. A characteristic extracting portion administers facial detection processes on the first ten photographs included in image group A, which have been obtained at photography point A. Facial areas and orientations of faces within the first ten photographs are extracted as characteristics of image group A. An eye detecting portion performs facial detection from within each photograph included in image group A, by determining the orientation of faces to be detected and areas from within which faces are to be detected, based on the characteristics of image group A obtained by the characteristic extracting portion. Then, the eye detecting portion detects eyes from within the detected faces.

### BACKGROUND OF THE INVENTION

1. Field of the Invention

The present invention relates to a method, apparatus, and program for trimming photographic images of faces. More specifically, the present invention relates to a method, apparatus, and program for trimming photographic images within image groups, each constituted by a plurality of photographic images of faces, which are photographed under the same photography conditions.

2. Description of the Related Art

Submission of photographic images picturing one's face in a predetermined format (hereinafter, referred to as “ID photo”) is often required, such as when applying for passports, driver's licenses, and employment. For this reason, automatic ID photo generating apparatuses are in common use. The automatic ID photo generating apparatuses have photography booths, within which users sit on chairs. The seated users are photographed to provide photographic images of users faces, to be used as ID photos, recorded on sheets. These automatic ID photo generating apparatuses are large, and installation locations thereof are limited. Therefore, users must search for and go to the locations at which the apparatuses are installed, which is inconvenient.

As a solution to the above problem, methods for producing trimmed images as ID photos have been proposed, for example, in Japanese Unexamined Patent Publication No. 11 (1999) -341272. This method displays a photographic image of a face (an image in which a face is pictured) to be employed to generate an ID photo on a display apparatus such as a monitor. The positions of the top of the head and the tip of the chin, within the displayed photographic image of the face, are specified and input to a computer. The computer determines the magnification ratio and the position of the face within the image, based on the two input positions and a predetermined format for an ID photo. The computer performs enlargement/reduction and trimming such that the face within the image is arranged at a predetermined position in the ID photo, thereby producing the ID photo according to the predetermined format. By the provision of such methods, users are enabled to request production of ID photos at DPE stores, which are present in greater numbers than automatic ID photo generating apparatuses. In addition, users are enabled to select images in which they appear most photogenic, from among images of themselves that they own. Generation of ID photos from such favored images is possible, by the user bringing photographic film or recording media, in which the favored images are recorded, to the DPE stores.

However, this method requires that an operator specify and input the positions of the top of the head and the tip of the chin within the displayed photographic images of faces, which is troublesome. Particularly in the case that ID photos are to be generated for a great number of users, the burden on the operator becomes great. In addition, there are cases in which the area of the facial region within a photographic image of a face is small, or the resolution of a photographic image of a face is low. In these cases, it is difficult for the operator to expediently and accurately specify and input the positions of the top of the head and the tip of the chin. Accordingly, there is a problem that suitable ID photos cannot be produced in an expedient manner.

Many methods that reduce the burden on an operator and that enable expedient and accurate setting of trimming areas have therefore been proposed. Particularly in recent years, automatic trimming process methods, which have become possible accompanying advances in techniques for automatically detecting faces and eyes from photographic images, are in the spotlight. According to these methods, ID photos can be generated without an operator specifying and inputting positions of the top of the head and the tip of the chin. For example, U.S. Patent Application Publication No. 20020085771 discloses a method for setting trimming areas. In this method, the positions of the top of the head and the eyes within a photographic image of a face are detected. Then, the position of the tip of the chin is estimated, based on the detected positions of the top of the head and the eyes, and a trimming area is set. Regarding automatic trimming processes, the most important process, which requires the most time and accuracy, is the detection of regions for setting a trimming area. The region may be the entire facial portion within an image, or may be the eyes (pupils).

Meanwhile, in cases, such as renewal of employee ID's at a business having many employees or issue and renewal of driver's licenses at the Department of Motor Vehicles, efficient processing is desired. That is, a work flow, in which the steps of: a subject is photographed to obtain a photographic image of a face; the photographic image of the face is trimmed to obtain a trimmed image; and an employee ID or a driver's license (hereinafter, collectively referred to as “ID card”) is generated employing the trimmed image are performed for each subject, is inefficient. Rather, a work flow, in which the photography process, the trimming process, and the ID card generation process are separated, is preferred. In the preferred work flow, individual subjects are photographed to obtain a great number of photographic images of faces, the photographic images of faces are trimmed to obtain a great number of trimmed images, and individual ID cards are issued employing the trimmed images. By adopting the preferred work flow, apparatuses and personnel for performing the photography process, the trimming process, and the ID card generating process can be specialized, which is more efficient. For example, a system may be considered, in which: photography is performed at a variety of photography points, which are spread out across a large area; an apparatus for performing trimming administers trimming processes to the photographic images of faces, which have been obtained at each photography point; and an apparatus for generating ID cards issues ID cards employing the trimmed images obtained by the trimming apparatus.

In the aforementioned automatic ID photo generating apparatus, photography conditions, such as the position where the person to be photographed sits and the position of their face, are generally fixed. Parameters related to trimming processes, such as the position, the size, and the orientation of the face, are also fixed and substantially the same. (Here, “orientation of the face” refers to the inclination of the face within the image. For example, in the examples illustrated in FIGS. 11A, 11B, and 11C, FIG. 11A illustrates a face which is vertically oriented, that is, inclined at 0 degrees. FIGS. 11B and 11C illustrate faces that are inclined −15 degrees and +15 degrees respectively, using the face of FIG. 11A as a reference.) Therefore, the automatic ID photo generating apparatus need only perform default processes based on the above parameters when trimming photographic images of faces, which are obtained by photography. Accordingly, processing by the automatic ID photo generating apparatus is fast. Further, because the aforementioned parameters are substantially fixed, the automatic ID photo generating apparatus can set fixed positions, as determined by the parameters, as the trimming area within the photographic images of faces, without detecting the faces therein. In comparison, in systems in which the photography process, the trimming process and the like are separated, there is a possibility that photography conditions differ among the great number of photographic images of faces to be trimmed. That is, the positions of the faces within each of the photographic images of faces may be different. Therefore, trimming areas are set after processes such as detecting faces are performed, in order to be able to perform trimming appropriately regardless of the photography conditions of the photographic images of faces. However, this requires more time for processing, and is inefficient.

### SUMMARY OF THE INVENTION

The present invention has been developed in view of the above circumstances. It is an object of the present invention to provide an apparatus, method, program, and system for trimming images, which is capable of efficiently performing trimming processes.

The method for trimming images of the present invention comprises the steps of:

detecting a trimming area setting region, which is a facial region or a predetermined region within a facial region, for setting a trimming area that includes the facial region from a photographic image of a face, to obtain a trimmed image, which is defined as that in which the facial region is arranged at a predetermined position and at a predetermined size;

setting the trimming area within the photographic image of the face, based on the trimming area setting region, such that the trimmed image matches the above definition; and

performing cutout and/or enlargement/reduction on the trimming area, to obtain the trimmed image; wherein:

characteristics that determine processing conditions of at least one of the detecting step, the setting step, the cutout and/or enlargement/reduction steps are obtained for each of at least one image group, constituted by a plurality of photographic images of faces, which are obtained by photographing people under the same photography conditions;

the processing conditions of the above steps are determined according to the characteristics; and

the steps are performed on the photographic images of the faces employing the determined processing conditions.

In the method for trimming images of the present invention, a configuration may be adopted wherein:

the photographic images of faces are those which are obtained at one of a plurality of photography points, each having different photography conditions; and

each of the image groups are constituted by photographic image of faces which are obtained at the same photography point.

In the method for trimming images of the present invention, a configuration may be adopted wherein:

the characteristics of the image groups are obtained by employing a portion of the photographic images of faces included in the image groups.

In the method for trimming images of the present invention, it is preferable that:

the characteristics include the size of the face within each of the photographic images of faces included in each of the image groups; and

the size of faces to be detected is determined based on the size of the face included in the characteristics, during detection of the trimming area setting region, which requires detection of faces.

In the method for trimming images of the present invention, it is preferable that:

the characteristics include the position of the face within each of the photographic images of faces included in each of the image groups;

the detection range for the trimming area setting region is determined based on the position of the face included in the characteristics; and

the trimming area setting region is performed within the detection range.

Here, the “position of the face” refers to data that represents the location at which the facial region is present within a photographic image of a face. The center position of a face, or the position of eyes within the facial region, for example, may be employed as the position of the face. The size of the face within a photographic image of a face is related to the size of the entire photographic image of the face. However, in facial photographs to be used as ID photos, the size of the face can be set to be 60% or less of the size of the entire photographic image of the face. Therefore, if the position of the face, for example, the center position of the face, is determined, an area having this position as the center thereof and including the face at 60% of its area (hereinafter, referred to as “facial area”) can be estimated. In the case that the size of the face is obtained as a characteristic of an image group, the facial area can be determined more accurately. Note that the “position of the face” as a characteristic of an image group includes a range of positions for each of the photographic images of faces. This is so that proper trimming areas can be set for photographic images of faces in each image group even if there is slight variation in the positions of the faces.

In the method for trimming images of the present invention, it is preferable that:

the characteristics include the orientation of the face in each of the photographic images of faces included in each of the image groups;

the orientation of faces to be detected is determined based on the orientation of the face included in the characteristics, during detection of the trimming area setting region, which requires detection of faces.

The image trimming apparatus of the present invention comprises:

a trimming area setting region detecting means, for detecting a trimming area setting region, which is a facial region or a predetermined region within a facial region, for setting a trimming area that includes the facial region from a photographic image of a face, to obtain a trimmed image, which is defined as that in which the facial region is arranged at a predetermined position and at a predetermined size;

a trimming area setting means, for setting the trimming area within the photographic image of the face, based on the trimming area setting region, such that the trimmed image matches the above definition;

a trimming means, for performing cutout and/or enlargement/reduction on the trimming area, to obtain the trimmed image; and

a characteristic obtaining means, for obtaining characteristics that determine processing conditions employed by at least one of the trimming area setting region detecting means, the trimming area setting means, and the trimming means for each of at least one image group, constituted by a plurality of photographic images of faces, which are obtained by photographing people under the same photography conditions; wherein

the processing conditions employed by at least one of the trimming area setting region detecting means, the trimming area setting means, and the trimming means are determined according to the characteristics; and

the trimming area setting region detecting means, the trimming area setting means, and the trimming means performs their respective processes on the photographic images of the faces employing the determined processing conditions.

In the image trimming apparatus of the present invention, a configuration may be adopted wherein:

the photographic images of faces are those which are obtained at one of a plurality of photography points, each having different photography conditions; and

each of the image groups are constituted by photographic image of faces which are obtained at the same photography point.

In the image trimming apparatus of the present invention, a configuration may be adopted wherein:

the characteristics of the image groups are obtained by employing a portion of the photographic images of faces included in the image groups.

In the image trimming apparatus of the present invention, it is preferable that:

the characteristics include the size of the face within each of the photographic images of faces included in each of the image groups; and

the size of faces to be detected is determined based on the size of the face included in the characteristics, during detection of the trimming area setting region, which requires detection of faces.

In the image trimming apparatus of the present invention, a configuration may be adopted wherein:

the characteristics include the position of the face within each of the photographic images of faces included in each of the image groups;

the detection range for the trimming area setting region is determined based on the position of the face included in the characteristics; and

the trimming area setting region is performed within the detection range.

In the image trimming apparatus of the present invention, it is preferable that:

the characteristics include the orientation of the face in each of the photographic images of faces included in each of the image groups;

the orientation of faces to be detected is determined based on the orientation of the face included in the characteristics, during detection of the trimming area setting region, which requires detection of faces.

The program of the present invention is that which causes a computer to execute the method for trimming images according to the present invention.

According to the present invention, first, characteristics that determine processing conditions of face/eye detection processes and trimming area setting processes, and cutout and/or enlargement/reduction processes are obtained. The characteristics are obtained for image groups constituted by photographic images of faces having the same photography conditions, such as those which are obtained at the same photography point. When trimming processes are administered on the photographic images of faces within an image group, processing conditions for the above processes are determined according to the characteristics obtained for that image group. By determining the processing conditions in this manner, the processes are expedited, and are efficiently performed. For example, the sizes of the faces in the photographic images of faces included in an image group may be obtained as the characteristic. Then, the size of faces to be detected maybe determined based on the size of the face included in the characteristics, during detection of faces. Thereby, the amount of calculations can be reduced, which is efficient. In addition, the positions of the faces may be obtained as the characteristic, and the detection range for the face may be determined, thereby reducing the amount of calculations. Further, the orientations of the faces may be obtained as the characteristic, and the orientation of faces to be detected may be determined based on this characteristic during detection of faces, eyes, or the like. Thereby, the amount of calculation can be reduced. Still further, there are cases in which cut out trimmed areas need to be enlarged or reduced, to match the predetermined format of ID photos. In these cases, if the enlargement/reduction ratio is obtained as the characteristic, then the obtained enlargement/reduction ratio may be employed in the enlargement/reduction process following cutout of the trimmed area from the photographic images of faces. This obviates the necessity of calculating enlargement/reduction ratios for each photographic image of a face.

Note that the program of the present invention may be provided being recorded on a computer readable medium. Those who are skilled in the art would know that computer readable media are not limited to any specific type of device, and include, but are not limited to: floppy disks, CD's, RAM's, ROM's, hard disks, magnetic tapes, and internet downloads, in which computer instructions can be stored and/or transmitted. Transmission of the computer instructions through a network or through wireless transmission means is also within the scope of this invention. Additionally, computer instructions include, but are not limited to: source, object and executable code, and can be in any language, including higher level languages, assembly language, and machine language.

### BRIEF DESCRIPTION OF THE DRAWINGS

FIG. 1 is a block diagram that illustrates the configuration of an ID card issuing system, which is an embodiment of the present invention.

FIG. 2 illustrates an example of the data structure of photographs which are stored in an image storing portion of the ID card issuing system of FIG. 1.

FIG. 3 is a block diagram that illustrates the configuration of a trimming processing portion.

FIG. 4 is a block diagram that illustrates the configuration of a characteristic extracting portion.

FIGS. 5A and 5B illustrate edge detection filters.

FIG. 6 is a diagram for explaining calculation of gradient vectors.

FIG. 7A illustrates a human face, and

FIG. 7B illustrates gradient vectors in the vicinities of the eyes and the mouth within the human face.

FIG. 8A illustrates a histogram that represents magnitudes of gradient vectors prior to normalization,

FIG. 8B illustrates a histogram that represents magnitudes of gradient vectors following normalization,

FIG. 8C illustrates a histogram that represents magnitudes of gradient vectors, which has been divided into five regions, and

FIG. 8D illustrates a histogram that represents normalized magnitudes of gradient vectors, which has been divided into five regions.

FIG. 9 illustrates examples of sample images, which are known to be of faces, employed during learning of first reference data E1, which is recorded in a second memory of the characteristic extracting portion.

FIG. 10 illustrates examples of sample images, which are known to be of faces, employed during learning of second reference data E2, which is recorded in a third memory of an eye detecting portion.

FIGS. 11A, 11B, and 11C are diagrams for explaining rotation of faces.

FIG. 12 is a flow chart that illustrates the learning technique for reference data.

FIG. 13 illustrates a technique for selecting discriminators.

FIG. 14 is a diagram for explaining stepwise deformation of photographs during detection of faces by the characteristic extracting portion.

FIG. 15 is a flow chart that illustrates the processes performed by the characteristic extracting portion.

FIG. 16 illustrates an example of the data structure of characteristics within a processing result database of the characteristic extracting portion.

FIG. 17 is a block diagram that illustrates the configuration of the eye detecting portion, of the trimming processing portion of FIG. 3.

FIGS. 18A and 18B are diagrams for explaining the center positions of eyes.

FIG. 19 is a flow chart that illustrates the processes performed by the eye detecting portion.

FIG. 20 is a block diagram that illustrates the configuration of a pupil center position detecting portion, of the trimming processing portion of FIG. 3

FIG. 21 is a diagram for explaining positions cutout by a cutout portion of the pupil center position detecting portion.

FIG. 22 is a diagram for explaining how a binarization threshold value is determined.

FIG. 23 is a diagram for explaining how poll values are weighted.

FIG. 24 is a flow chart that illustrates the processes performed by the pupil center position detecting portion.

FIG. 25 is a block diagram that illustrates the configuration of a trimming area obtaining portion, of the trimming processing portion of FIG. 3.

FIG. 26 is a flow chart that illustrates the processes performed by an ID card production center.

### DESCRIPTION OF THE PREFERRED EMBODIMENTS

Hereinafter, an embodiment of the present invention will be described with reference to the attached drawings.

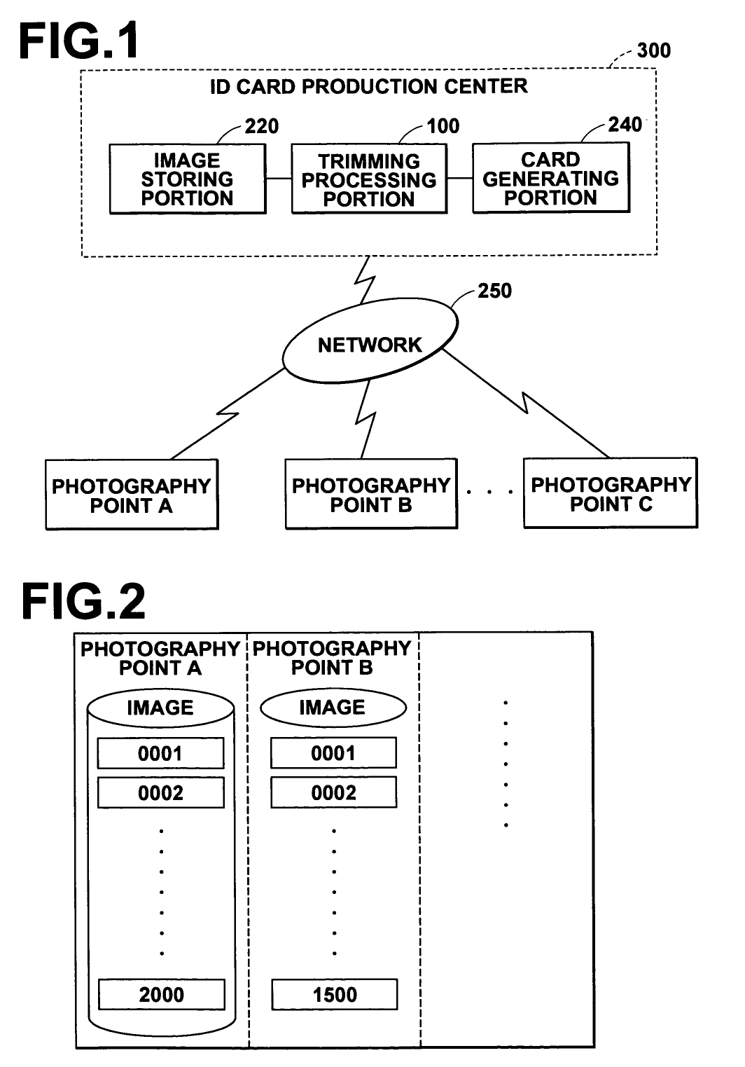

FIG. 1 is a block diagram that illustrates the configuration of an ID card issuing system, which is an embodiment of the present invention. The card issuing system of the present embodiment comprises: a plurality of photography points, at which people for whom ID cards are to be generated are photographed to obtain photographic images of faces (hereinafter, simply referred to as “photographs”); an ID card production center 300, for generating ID cards employing the photographs obtained at the photography points. A network 250 connects each of the photography points with the ID card production center 300. The photographs, which are obtained at the photography points, are transmitted to the ID card production center 300 via the network 250.

When the photographs, which are obtained at the photography points, are transmitted to the ID card production center 300, data that indicates at which photography point the photograph was obtained (such as photography point A, photography point B) is attached thereto.

The ID card production center 300 comprises: an image storing portion 220, for storing the photographs transmitted from each photography point, classified by the photography point; a trimming processing portion 100, for performing trimming processes on the photographs stored in the image storing portion 220 to obtain trimmed images; and a card generating portion 240, for generating ID cards employing the trimmed images, obtained by the trimming processing portion 100.

The image storing portion 220 of the ID card production center 300 reads out data attached to the photographs, which are transmitted thereto from each of the photography points, and stores the photographs according to the photography points. FIG. 2 illustrates an example of the data structure of photographs which are stored in the image storing portion 220. As illustrated in FIG. 2, photographs from each photography point are recorded in a memory region corresponding to the respective photography point.

The trimming processing portion 100 obtains trimmed images by performing trimming processes on photographs, which are stored in the image storing portion 220. Here, a case will be described in which employee ID's are renewed for a company that has offices all over the country and about 10,000 employees. The ID card production center 300 receives photographs of employees from photography points for the main office and all of the branch offices. The trimming processing portion 100 performs processes, such as: facial detection, eye detection, setting of trimming areas, and cutout, according to the format of the photographs to be pasted onto the employee ID's. Note that because it is necessary for the size of the trimmed images to match the format, the trimming processing portion 100 also performs enlargement/reduction processes as necessary. Here, the configuration of the trimming processing portion 100 will be described in detail.

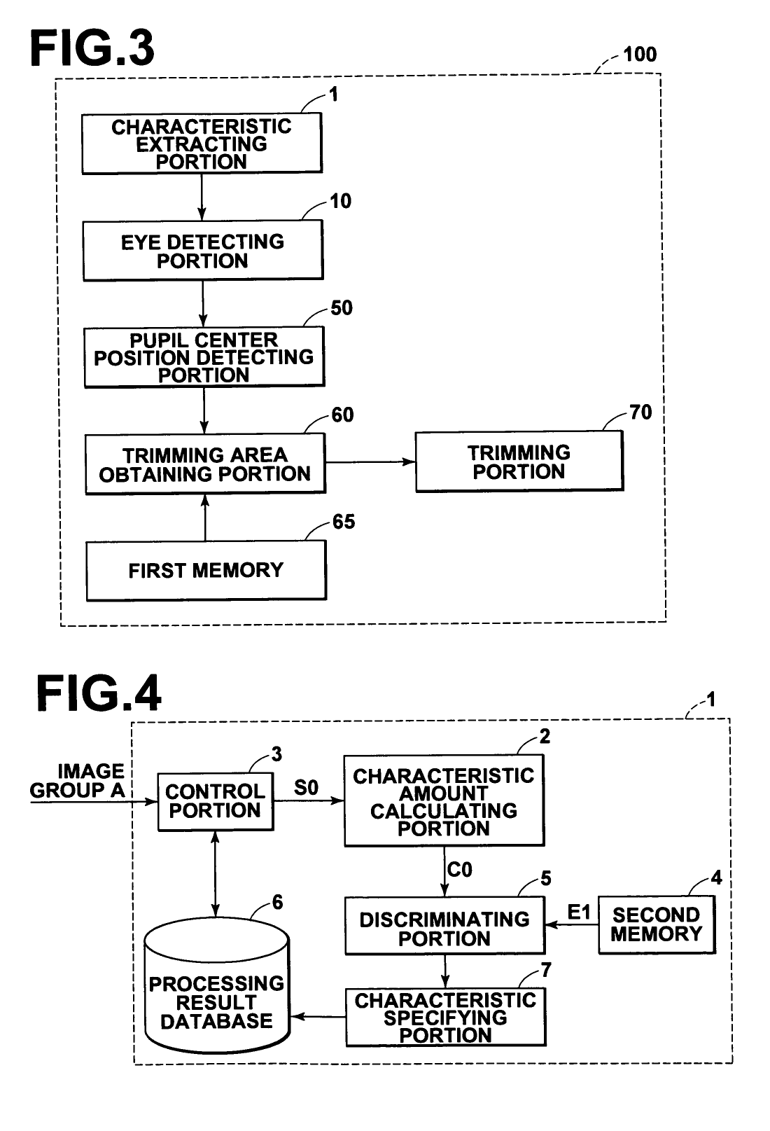

FIG. 3 is a block diagram that illustrates the configuration of the trimming processing portion 100, of the ID card production center 300 of FIG. 1. As illustrated in FIG. 3, the trimming processing portion 100 comprises: a characteristic extracting portion 1, an eye detecting portion 10, a pupil center position detecting portion 50, a trimming area obtaining portion 60, a trimming portion, and a first memory 65. Note that the trimming processing portion 100 performs trimming processes separately on photographs from each photography point. Here, an example will be described in which processes are performed on photographs obtained at photography point A.

The characteristic extracting portion 1 extracts characteristics from the group of photographs transmitted from photography point A (images 0001 through 0020 stored in the memory region corresponding to photography point A in FIG. 2, hereinafter referred to as “image group A”) stored in the image storing portion 220. More specifically, characteristics are extracted from a portion of the photographs of image group A (here, the first ten photographs 0001 through 0010 in FIG. 2). Here, characteristics refer to characteristics related to trimming processes. In the present embodiment, the characteristic extracting portion 1 extracts facial areas (position and size of faces) and the orientation of the face as characteristics of image group A. Photography conditions, such as the position at which the subject sits and the size of the subject within the photograph may differ among different photography points. However, the photography conditions are the same at a single photography point. Therefore, it is considered that the positions, the sizes, and the orientations of faces within photographs obtained at the same photography point are substantially the same.

FIG. 4 is a block diagram that illustrates the configuration of the characteristic extracting portion 1. As illustrated in FIG. 4, the characteristic extracting portion 1 comprises: a characteristic calculating portion 2, for calculating characteristic amounts C0 of the aforementioned ten photographs; a second memory 4, in which first reference data E1, to be described later, is stored; a discriminating portion 5, for detecting human faces within photographs and obtaining the positions, sizes, and orientations of the faces, based on the characteristic amounts C0 and the first reference data E1; a characteristic specifying portion 7, for obtaining facial areas and facial orientations within the image group A, based on the position, size, and orientation of the face in each of the aforementioned ten photographs obtained by the discriminator, and specifying the facial areas and facial orientations as characteristics of image group A; a control portion 3, and a processing result database 6.

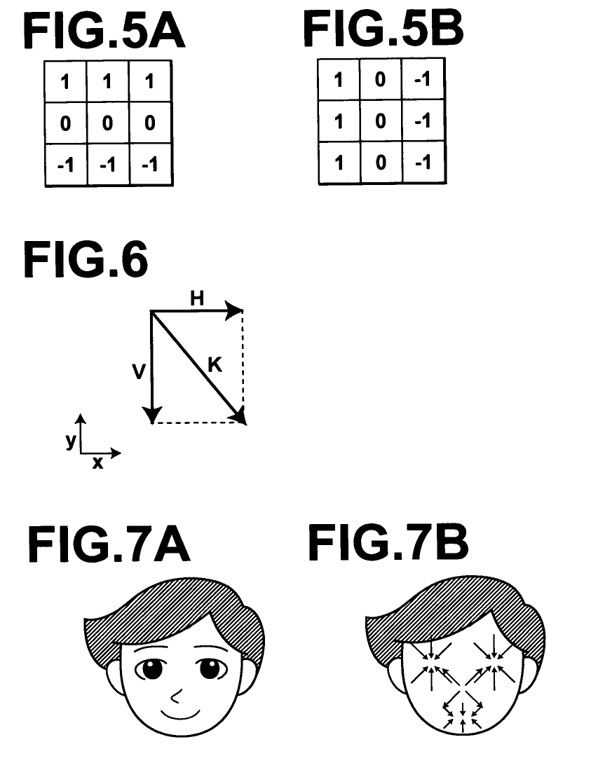

The characteristic amount calculating portion 2 calculates the characteristic amounts C0, which are employed to discriminate faces, from a photograph (hereinafter, referred to as “photograph S0”). Specifically, gradient vectors (the direction and magnitude of density change at each pixel within the photograph S0) are calculated as the characteristic amounts C0. Hereinafter, calculation of the gradient vectors will be described. First, the characteristic amount calculating portion 2 detects edges in the horizontal direction within the photograph S0, by administering a filtering process with a horizontal edge detecting filter, as illustrated in FIG. 5A. The characteristic amount calculating portion 2 also detects edges in the vertical direction within the photograph S0, by administering a filtering process with a vertical edge detecting filter, as illustrated in FIG. 5B. Then, gradient vectors K for each pixel of the photograph S0 are calculated from the size H of horizontal edges and the size V of the vertical edges, as illustrated in FIG. 6. Note that the characteristic amount calculating portion 2 calculates the characteristic amounts C0 at each step in the deformation of the photograph S0 and a facial image, as will be described later.

In the case that a human face, such as that illustrated in FIG. 7A, is included in the photograph S0, the gradient vectors K, which are calculated in the manner described above, are directed toward the centers of eyes and mouths, which are dark, and are directed away from noses, which are bright, as illustrated in FIG. 7B. In addition, the magnitudes of the gradient vectors K are greater for the eyes than for the mouth, because changes in density are greater for the eyes than for the mouth.

The directions and magnitudes of the gradient vectors K are designated as the characteristic amounts C0. Note that the directions of the gradient vectors K are values between 0 and 359, representing the angle of the gradient vectors K from a predetermined direction (the x-direction in FIG. 6, for example).

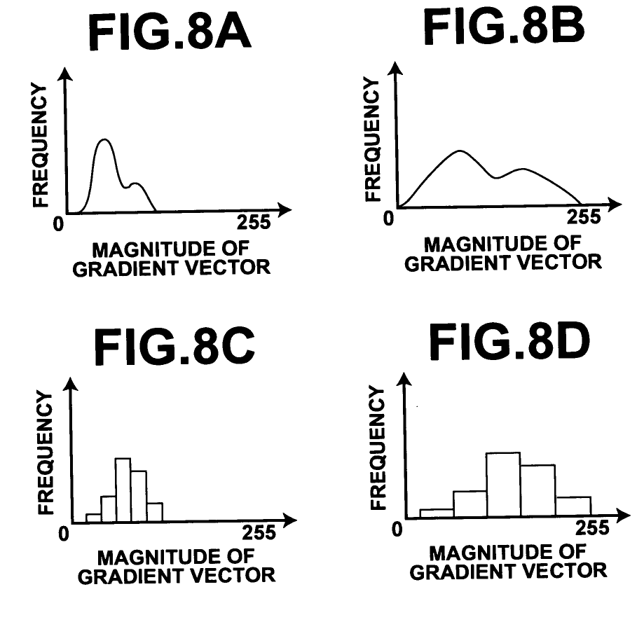

Here, the magnitudes of the gradient vectors K are normalized. The normalization is performed in the following manner. First, a histogram that represents the magnitudes of the gradient vectors K of all of the pixels within the photograph S0 is derived. Then, the magnitudes of the gradient vectors K are corrected, by flattening the histogram so that the distribution of the magnitudes is evenly distributed across the range of values assumable by each pixel of the candidate image (0 through 255 in the case that the image data is 8 bit data). For example, in the case that the magnitudes of the gradient vectors K are small and concentrated at the low value side of the histogram, as illustrated in FIG. 8A, the histogram is redistributed so that the magnitudes are distributed across the entire range from 0 through 255, as illustrated in FIG. 8B. Note that in order to reduce the amount of calculations, it is preferable that the distribution range of the gradient vectors K in a histogram be divided into five, for example, as illustrated in FIG. 8C. Then, the gradient vectors K are normalized by redistributing the histogram such that the frequency distribution, which has been divided into five, is distributed across the entire range of values from 0 through 255, as illustrated in FIG. 8D.

The first reference data E1, which is stored in the second memory 4, defines discrimination conditions for combinations of the characteristic amounts C0 for each pixel of each of a plurality of types of pixel groups, which are constituted by a plurality of pixels selected from sample images, to be described later.

The combinations of the characteristic amounts C0 and the discrimination conditions within the first reference data E are set in advance by learning. The learning is performed by employing a sample image group comprising a plurality of sample images, which are known to be of faces, and a plurality of sample images, which are known to not be of faces.

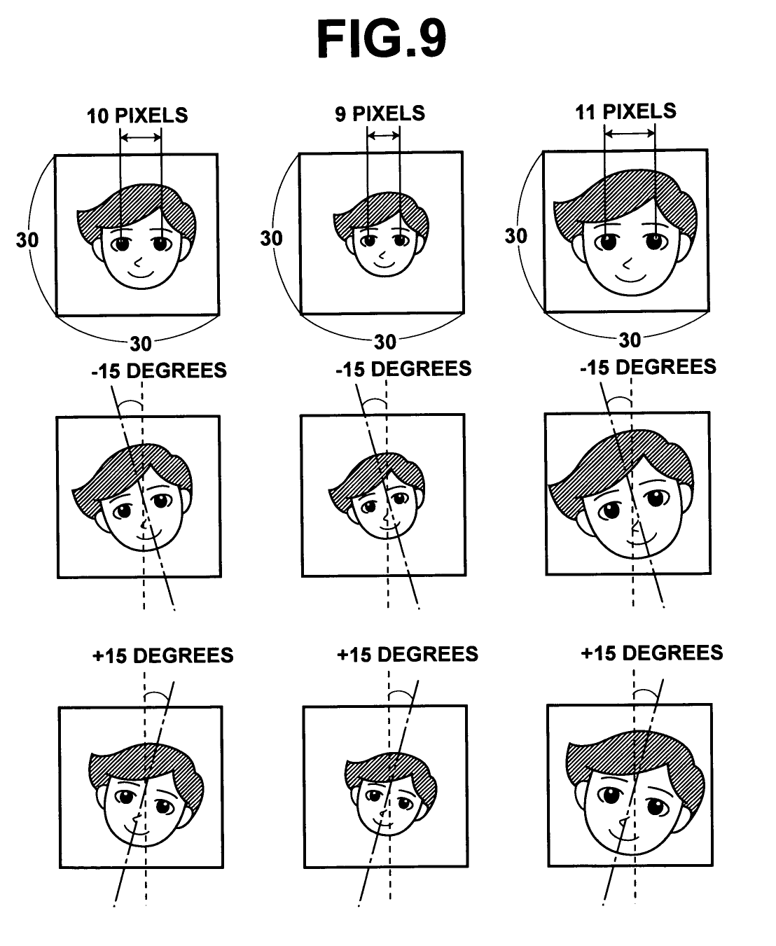

Note that in the present embodiment, the sample images, which are known to be of faces and are utilized to generate the first reference data E1, have the following specifications. That is, the sample images are of a 30×30 pixel size, the distances between the centers of the eyes of each face within the images are one of 9, 10, or 11 pixels, and the faces are rotated stepwise in three degree increments within a range of ±15 degrees from the vertical (that is, the rotational angles are −15 degrees, −12 degrees, −9 degrees, −6 degrees, 0 degrees, 3 degrees, 6 degrees, 9 degrees, 12 degrees, and 15 degrees). Accordingly, 33 sample images (3×11) are prepared for each face. Note that only sample images which are rotated −15 degrees, 0 degrees, and 15 degrees are illustrated in FIG. 9. The centers of rotation are the intersections of the diagonals of the sample images. Here, if the distance between the eyes is 10 pixels in the sample images, then the central positions of the eyes are all the same. The central positions of the eyes are designated as (x1, y1) and (x2, y2) on a coordinate plane having the upper left corner of the sample image as its origin. The positions of the eyes in the vertical direction (that is, y1 and y2) are the same for all of the sample images.

Arbitrary images of a 30×30 pixel size are employed as the sample images which are known to not be of faces.

Consider a case in which sample images, in which the distance between the eyes are 10 pixels and the rotational angle is 0 degrees (that is, the faces are in the vertical orientation), are employed exclusively to perform learning. In this case, only those faces, in which the distance between the eyes are 10 pixels and which are not rotated at all, would be discriminated by referring to the first reference data E1. The sizes of the faces, which are possibly included in the photographs S0, are not uniform in size. Therefore, during discrimination regarding whether a face is included in the photograph, the photograph S0 is enlarged/reduced, to enable discrimination of a face of a size that matches that of the sample images. However, in order to maintain the distance between the centers of the eyes accurately at ten pixels, it is necessary to enlarge and reduce the photograph S0 in a stepwise manner with magnification rates in 1.1 units, thereby causing the amount of calculations to be great.

In addition, faces, which are possibly included in the photographs S0, are not only those which have rotational angles of 0 degrees, as that illustrated in FIG. 11A. There are cases in which the faces in the photographs are rotated, as illustrated in FIG. 11B and FIG. 11C. However, in the case that sample images, in which the distance between the eyes are 10 pixels and the rotational angle is 0 degrees, are employed exclusively to perform learning, rotated faces such as those illustrated in FIG. 11B and FIG. 11C would not be discriminated as faces.

For these reasons, the present embodiment imparts an allowable range to the first reference data E1. This is accomplished by employing sample images, which are known to be of faces, in which the distances between the centers of the eyes are 9, 10, and 11 pixels, and which are rotated in a stepwise manner in three degree increments within a range of ±15 degrees. Thereby, the photograph S0 may be enlarged/reduced in a stepwise manner with magnification rates in 11/9 units, which enables reduction of the time required for calculations, compared to a case in which the photograph S0 is enlarged/reduced with magnification rates in 1.1 units. In addition, rotated faces, such as those illustrated in FIG. 11B and FIG. 11C, are also enabled to be discriminated.

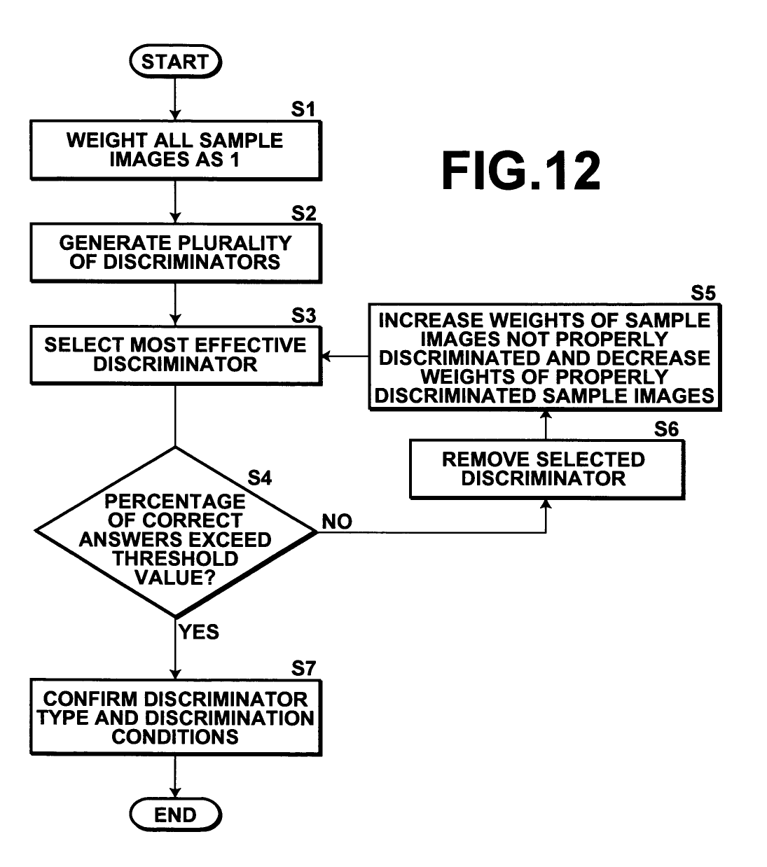

Hereinafter, an example of a learning technique employing the sample images will be described with reference to the flow chart of FIG. 12.

The sample images, which are the subject of learning, comprise a plurality of sample images, which are known to be of faces, and a plurality of sample images, which are known to not be of faces. Note that the in sample images, which are known to be of faces, the distances between the centers of the eyes of each face within the images are one of 9, 10, or 11 pixels, and the faces are rotated stepwise in three degree increments within a range of ±15 degrees from the vertical. Each sample image is weighted, that is, is assigned a level of importance. First, the initial values of weighting of all of the sample images are set equally to 1 (step S1).

Next, discriminators are generated for each of the different types of pixel groups of the sample images (step S2). Here, each discriminator has a function of providing a reference to discriminate images of faces from those not of faces, by employing combinations of the characteristic amounts C0, for each pixel that constitutes a single pixel group. In the present embodiment, histograms of combinations of the characteristic amounts C0 for each pixel that constitutes a single pixel group are utilized as the discriminators.

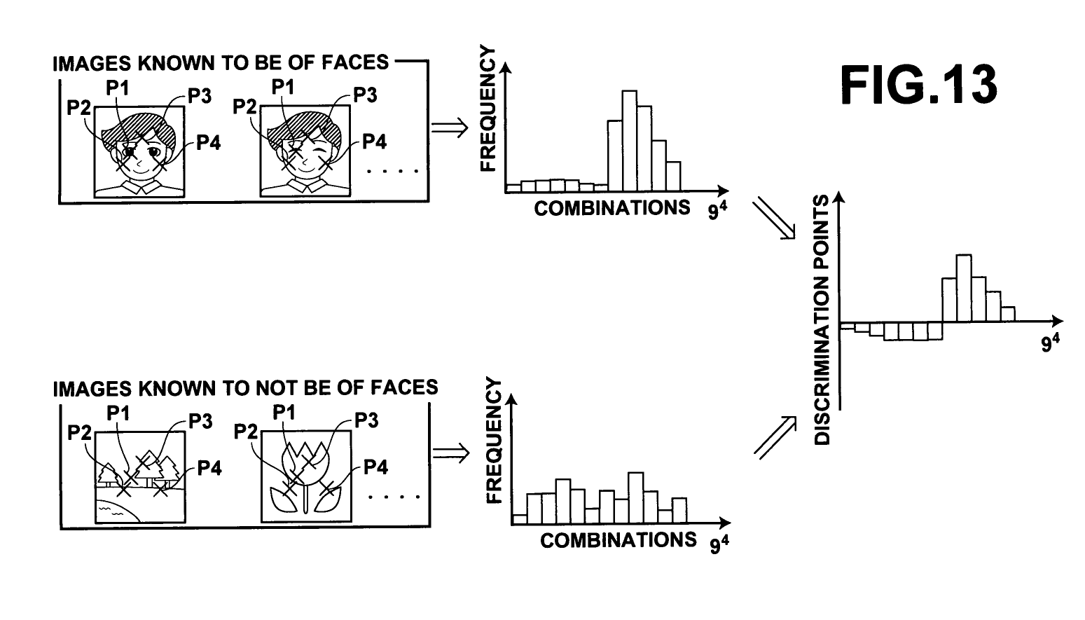

The generation of a discriminator will be described with reference to FIG. 13. As illustrated in the sample images at the left side of FIG. 13, the pixels that constitute the pixel group for generating the discriminator are: a pixel P1 at the center of the right eye; a pixel P2 within the right cheek; a pixel P3 within the forehead; and a pixel P4 within the left cheek, of the sample images which are known to be of faces. Combinations of the characteristic amounts C0 of the pixels P1 through P4 are obtained for all of the sample images, which are known to be of faces, and histograms thereof are generated. Here, the characteristic amounts C0 represent the directions and magnitudes of the gradient vectors K. However, there are 360 possible values (0 through 359) for the direction of the gradient vector K, and 256 possible values (0 through 255) for the magnitude thereof. If these values are employed as they are, the number of combinations would be four pixels at 360×256 per pixel, or (360×256)⁴, which would require a great number of samples, time, and memory for learning and detection. For this reason, in the present embodiment, the directions of the gradient vectors K are quaternarized, that is, set so that: values of 0 through 44 and 315 through 359 are converted to a value of 0 (right direction); values of 45 through 134 are converted to a value of 1 (upper direction); values of 135 through 224 are converted to a value of 2 (left direction); and values of 225 through 314 are converted to a value of 3 (lower direction). The magnitudes of the gradient vectors K are ternarized so that their values assume one of three values, 0 through 2. Then, the values of the combinations are calculated employing the following formulas.

Value of Combination=0 (in the case that the magnitude of the gradient vector is 0); and

Value of Combination=(direction of the gradient vector+1)×magnitude of the gradient vector (in the case that the magnitude of the gradient vector>0).

Due to the above quaternarization and ternarization, the possible number of combinations becomes 9⁴, thereby reducing the amount of data of the characteristic amounts C0.

In a similar manner, histograms are generated for the plurality of sample images, which are known to not be of faces. Note that in the sample images, which are known to not be of faces, pixels (denoted by the same reference numerals P1 through P4) at positions corresponding to the pixels P1 through P4 of the sample images, which are known to be of faces, are employed in the calculation of the characteristic amounts C0. Logarithms of the ratios of the frequencies in the two histograms are represented by the rightmost histogram illustrated in FIG. 13, which is employed as the discriminator. According to the discriminator, images that have distributions of the characteristic amounts C0 corresponding to positive discrimination points therein are highly likely to be of faces. The likelihood that an image is of a face increases with an increase in the absolute values of the discrimination points. On the other hand, images that have distributions of the characteristic amounts C0 corresponding to negative discrimination points of the discriminator are highly likely to not be of faces. Again, the likelihood that an image is not of a face increases with an increase in the absolute values of the negative discrimination points. A plurality of discriminators are generated in histogram format regarding combinations of the characteristic amounts C0 of each pixel of the plurality of types of pixel groups, which are utilized during discrimination, in step S2.

Thereafter, a discriminator, which is most effective in discriminating whether an image is of a face, is selected from the plurality of discriminators generated in step S2. The selection of the most effective discriminator is performed while taking the weighting of each sample image into consideration. In this example, the percentages of correct discriminations provided by each of the discriminators are compared, and the discriminator having the highest weighted percentage of correct discriminations is selected (step S3). At the first step S3, all of the weighting of the sample images are equal, at 1. Therefore, the discriminator that correctly discriminates whether sample images are of faces with the highest frequency is selected as the most effective discriminator. On the other hand, the weightings of each of the sample images are renewed at step S5, to be described later. Thereafter, the process returns to step S3. Therefore, at the second step S3, there are sample images weighted with 1, those weighted with a value less than 1, and those weighted with a value greater than 1. Accordingly, during evaluation of the percentage of correct discriminations, a sample image, which has a weighting greater than 1, is counted more than a sample image, which has a weighting of 1. For these reasons, from the second and subsequent step S3's, more importance is placed on correctly discriminating heavily weighted sample images than lightly weighted sample images.

Next, confirmation is made regarding whether the percentage of correct discriminations of a combination of the discriminators which have been selected exceeds a predetermined threshold value (step S4). That is, the percentage of discrimination results regarding whether sample images are of faces, which are obtained by the combination of the selected discriminators, that match the actual sample images is compared against the predetermined threshold value. Here, the sample images, which are employed in the evaluation of the percentage of correct discriminations, may be those that are weighted with different values, or those that are equally weighted. In case that the percentage of correct discriminations exceeds the predetermined threshold value, whether an image is of a face can be discriminated by the selected discriminators with sufficiently high accuracy, therefore the learning process is completed. In the case that the percentage of correct discriminations is less than or equal to the predetermined threshold value, the process proceeds to step S6, to select an additional discriminator, to be employed in combination with the discriminators which have been selected thus far.

The discriminator, which has been selected at the immediately preceding step S3, is excluded from selection in step S6, so that it is not selected again.

Next, the weighting of sample images, which were not correctly discriminated by the discriminator selected at the immediately preceding step S3, is increased, and the weighting of sample images, which were correctly discriminated, is decreased (step S5). The reason for increasing and decreasing the weighting in this manner is to place more importance on images which were not correctly discriminated by the discriminators that have been selected thus far. In this manner, selection of a discriminator which is capable of correctly discriminating whether these sample images are of a face is encouraged, thereby improving the effect of the combination of discriminators.

Thereafter, the process returns to step S3, and another effective discriminator is selected, using the weighted percentages of correct discriminations as a reference.

The above steps S3 through S6 are repeated to select discriminators corresponding to combinations of the characteristic amounts C0 for each pixel that constitutes specific pixel groups, which are suited for discriminating whether faces are included in images. If the percentages of correct discriminations, which are evaluated at step S4, exceed the threshold value, the type of discriminator and discrimination conditions, which are to be employed in discrimination regarding whether images include faces, are determined (step S7), and the learning of the first reference data E1 is completed.

Note that in the case that the learning technique described above is applied, the discriminators are not limited to those in the histogram format. The discriminators may be of any format, as long as they provide references to discriminate between images of faces and other images by employing combinations of the first characteristic amounts E1 of each pixel that constitutes specific pixel groups. Examples of alternative discriminators are: binary data, threshold values, functions, and the like. As a further alternative, a histogram that represents the distribution of difference values between the two histograms illustrated in the center of FIG. 13 may be employed, in the case that the discriminators are of the histogram format.

The learning technique is not limited to that which has been described above. Other machine learning techniques, such as a neural network technique, may be employed.

The discriminating portion 5 refers to the discrimination conditions of the first reference data E1, which has been learned regarding every combination of the characteristic amounts C0 of each pixel that constitutes a plurality of types of pixel groups. Thereby, the discrimination points of the combinations of the characteristic amounts C0 of each pixel that constitutes each of the pixel groups are obtained. Whether a face is included in the photograph S0 is discriminated by totaling the discrimination points. At this time, of the characteristic amounts C0, the directions of the gradient vectors K are quaternarized, and the magnitudes of the gradient vectors K are ternarized. In the present embodiment, discrimination is performed based on whether the sum of all of the discrimination points exceeds a predetermined threshold value (hereinafter, referred to as “facial discrimination threshold value”). For example, in the case that the total sum of the discrimination points is greater than or equal to the facial discrimination threshold value, it is judged that a face is included in the photograph S0. In the case that the total sum of the discrimination points is less than the facial discrimination threshold value, it is judged that a face is not included in the photograph S0.

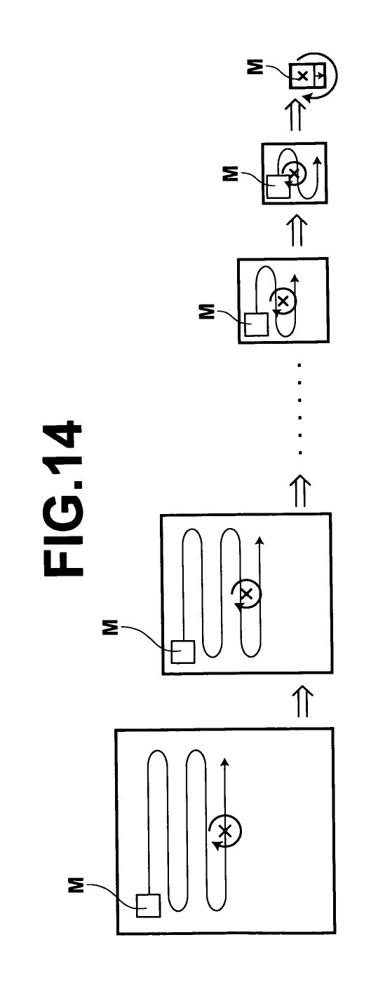

Here, the sizes of the photographs S0 are varied, unlike the sample images, which are 30×30 pixels. In addition, in the case that a face is included in the photograph S0, the face is not necessarily in the vertical orientation. For these reasons, the discriminating portion 5 enlarges/reduces the photograph S0 in a stepwise manner (FIG. 14 illustrates a reduction process), so that the size thereof becomes 30 pixels in either the vertical or horizontal direction. In addition, the photograph S0 is rotated in a stepwise manner over 360 degrees. A mask M, which is 30×30 pixels large, is set on the photograph S0, at every stepwise increment of the enlargement/reduction. The mask M is moved one pixel at a time on the photograph S0, and whether a face is included in the photograph S0 is discriminated, by discriminating whether the image within the mask is that of a face.

Note that during learning of the first reference data E1, sample images are utilized, in which the distances between the centers of the eyes are one of 9, 10, and 11 pixels. Therefore, the magnification rate during enlargement/reduction of the photograph S0 may be set to be 11/9. In addition, during learning of the first reference data E1, sample images are utilized, in which faces are rotated within a range of ±15 degrees. Therefore, the photograph S0 and the candidate may be rotated over 360 degrees in 30 degree increments.

Here, the characteristic amount calculating portion 2 calculates the characteristic amounts C0 from the photograph S0 at each step of their stepwise enlargement/reduction and rotational deformation.

Discrimination regarding whether a face is included in the photograph S0 is performed at every step in the stepwise enlargement/reduction and rotational deformation thereof. In the case that a face is discriminated once, the photograph S0 is discriminated to include the face. A region 30×30 pixels large, corresponding to the position of the mask M at the time of discrimination, is extracted from the photograph S0 at the step in the stepwise size and rotational deformation at which the face was discriminated, as an image of the face (hereinafter, referred to as “facial image”). Here, each of the steps corresponds to the enlargement/reduction ratio and the rotational angle of the photograph S0. Therefore, the discriminating portion 5 obtains the orientation, the position, and the size (the size prior to enlargement/reduction) of the face based on the step at which the facial image was extracted.

The characteristic amount calculating portion 2 and the discriminating portion 5 performs the above processes on the first ten photographs of image group A. The orientation, the position and the size of the faces (facial area) are obtained and output to the characteristic specifying portion 7.

The characteristic specifying portion 7 specifies the orientation of the faces, obtained for each of the ten photographs by the discriminating portion 5, as the orientation of the faces in the photographs included in image group A. At the same time, the facial areas obtained by the discriminating portion 5 are also set as the facial areas in the photographs included in image group A. In this manner, the characteristics of image group A are specified.

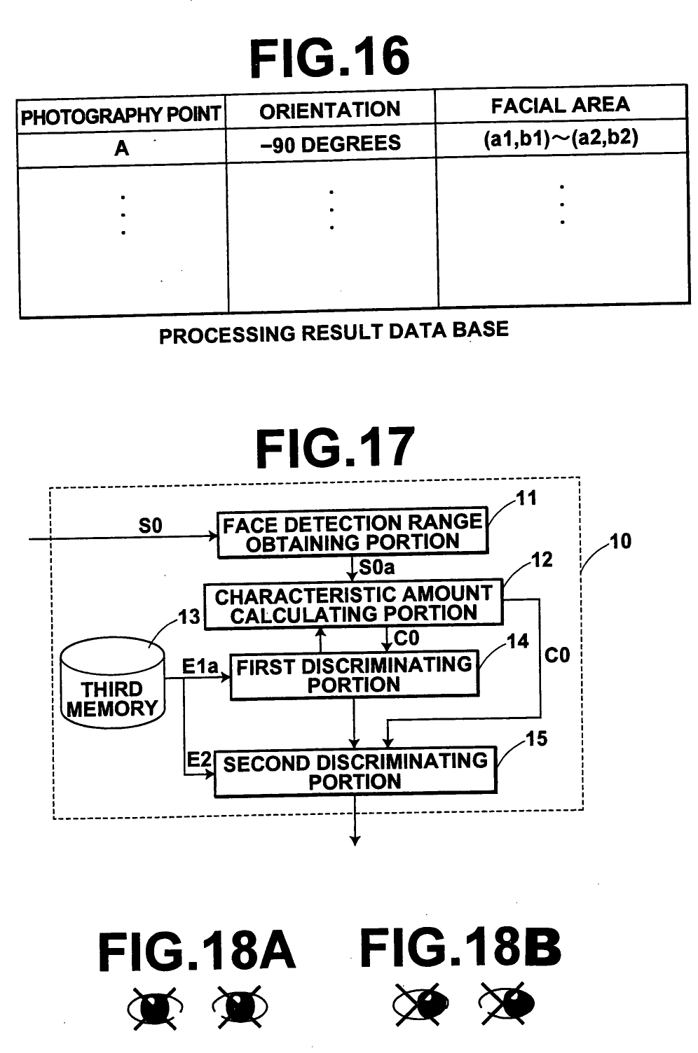

The characteristic specifying portion 7 outputs the characteristics of image group A to the eye detecting portion 10 of the trimming processing portion 100 illustrated in FIG. 3. At the same time, the characteristics of image group A are registered in the processing result database 6, as characteristics of photography point A. FIG. 16 illustrates an example of the data structure of characteristics within the processing result database 6. As illustrated in FIG. 16, the characteristics of photography points obtained from the characteristic specifying portion 7 are recorded in the processing result database 6 for each photography point. That is, data indicating the orientation of the face and the facial area at each photography point is recorded in the processing result database 6. In the example of FIG. 16, the angle of inclination of the face is recorded as the orientation of the faces, and an upper left pixel position (a1, b1) and a lower right pixel position (a2, b2) of the facial region are recorded as the facial area, corresponding to each photography point.

The processes performed by the characteristic amount calculating portion 2, the discriminating portion 5, and the characteristic specifying portion 7 of the characteristic extracting portion 1 have been described. These processes are performed according to commands from the control portion 3. First, the control portion 3 obtains data, which is attached to the photographs of image group A, that indicate the photography point (photography point A), and references the processing result database 6 with the data. If the characteristics of photography point A are recorded in the processing result database 6, the characteristics are read out and directly output to the eye detecting portion 10. However, if the characteristics of photography point A are not recorded in the processing result database 6, the first ten photographs of image group A are output to the characteristic amount calculating portion 2. Thereafter, the processes described above, such as calculation of characteristic amounts, discrimination of faces, specification of the characteristics, and registration in the processing result database 6, are performed.

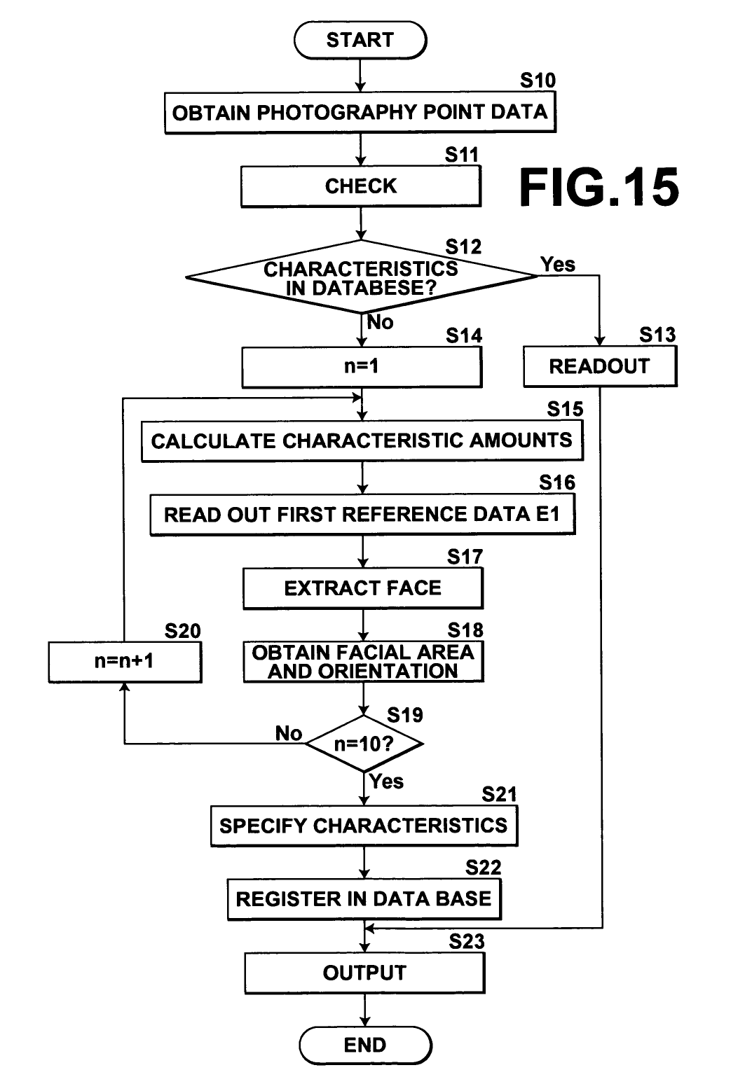

FIG. 15 is a flow chart that illustrates the processes performed by the characteristic extracting portion 1. As illustrated in FIG. 15, first, the control portion 3 obtains data, which is attached to the photographs of image group A, that indicate the photography point (photography point A), and references the processing result database 6 to confirm whether characteristics corresponding to the photography point are recorded therein (steps S10 and S11). If the characteristics of photography point A are recorded in the processing result database 6 (step S12: YES), the characteristics are read out and directly output to the eye detecting portion 10 (steps S13 and S23). On the other hand, if the characteristics of photography point A are not recorded in the processing result database 6 (step S12: NO), the first ten photographs of image group A are output to the characteristic amount calculating portion 2. Thereafter, the processes of steps S14 through S23 are performed. The characteristic amount calculating means 2 calculates the directions and magnitudes of the gradient vectors K of the first photograph of image group A, as the characteristic amounts C0, at each step in the stepwise enlargement/reduction and rotation thereof (steps S14 and S15). Then, the discriminating portion 5 reads the first reference data E1 out from the second memory 4 (step S16), and performs discrimination regarding whether the photograph includes a face. A region 30×30 pixels large, corresponding to the position of the mask M at the time of discrimination, is extracted from the photograph at the step in the stepwise size and rotational deformation at which the face was discriminated, as a facial image (step S17). At the same time, the orientation of the face and the facial area within the photograph is obtained (step S18). The characteristic amount calculating portion 2 and the discriminating portion 5 of the characteristic extracting portion 1 perform the processes of steps S14 through S18 on the first ten photographs of image group A. The results of the processes administered on each of the photographs are output to the characteristic specifying portion 7 (steps S15 through S20). The characteristic specifying portion 7 specifies the characteristics of image group of A, such that: the orientation of the faces of image group A is the same as those obtained for the ten photographs by the discriminating portion 5; and the facial area within the photographs of image group A is the same as those obtained for the ten photographs by the discriminating portion 5 (step S21). The control portion 3 registers the characteristics of image group A, obtained from the characteristic specifying portion 7, in the processing result database 6 (step 22). At the same time, the control portion 3 also outputs the characteristics of image group A to the eye detecting portion 10 (S23).

The eye detecting portion 10 utilizes the characteristics of image group A, output from the characteristic extracting portion 1, to detect the eyes within the photographs included in image group A. FIG. 17 is a block diagram that illustrates the configuration of the eye detecting portion 10. As illustrated in FIG. 17, the eye detecting portion 10 comprises: a face detection range obtaining portion 11, for extracting a range, within which faces are to be detected, from the photograph S0 and obtaining an extraction range image S0a; a characteristic amount calculating portion 12, for calculating characteristic amounts C0 from the extraction range image S0a and a facial image, to be described later; a third memory 13, in which first and second reference data E1a and E2, to be described later, are recorded; a first discriminating portion 14, for discriminating whether a face is included in the photograph S0, based on the characteristic amounts C0, calculated by the characteristic amount calculating means 12, and the first reference data E1a, stored in the third memory 13; and a second discriminating portion 15, for discriminating the positions of eyes within a facial image extracted by the first discriminating portion 14, based on the characteristic amounts C0, calculated by the characteristic amount calculating means 12 and the second reference data E2, stored in the third memory 13.

Note that the “positions of eyes” to be discriminated by the eye detecting portion 10 refers to the center positions between the corners of the eyes. In the case that the eyes face front, as illustrated in FIG. 18A, the centers are the irises (denoted by X's in FIG. 18A). In the case that the eyes are looking toward the right, as illustrated in FIG. 18B, the centers are not the irises, but the whites of the eyes.

The face detection range obtaining portion 11 extracts the extraction range image S0a, within which faces are to be detected, from the photograph S0, based on the characteristics of image group A, output by the characteristic extracting portion 1. Specifically, an image of the facial range (for example, a rectangle having the coordinate positions (a1, b1) and (a2, b2) as two of its corners), which is one of the characteristics of image group A, is extracted. The extracted image is rotated, based on the orientation of the face, which is the other characteristic of image group A, to obtain an extraction range image S0a, in which the face is vertically oriented, as illustrated in FIG. 11A. The extraction range image S0a obtained in this manner is an image that includes a face, and that in which the orientation of the face is vertical (the planar rotational angle thereof is 0 degrees).

The characteristic amount calculating portion 12 calculates characteristic amounts C0, to be employed in the discrimination of faces, from the extraction range image S0a. The characteristic amount calculating portion 12 also calculates characteristic amounts C0 from a facial image, which is extracted from the extraction range image S04 by the first discriminating portion 14, as will be described later. Note that the operation of the characteristic calculating portion 12 is the same as that of the characteristic calculating portion 2, except that the subject of the processing is the extraction range image S0a, which is a portion or a rotated portion of the photograph S0, instead of the photograph S0. Therefore, a detailed description of the operation of the characteristic calculating portion 12 will be omitted.

The first and second reference data E1a and E2, which are stored in the third memory 13, define discrimination conditions for combinations of the characteristic amounts C0 for each pixel of each of a plurality of types of pixel groups, which are constituted by a plurality of pixels selected from sample images, to be described later.

The combinations of the characteristic amounts C0 and the discrimination conditions within the first reference data E1a and the second reference data E2 are set in advance by learning. The learning is performed by employing an image group comprising a plurality of sample images, which are known to be of faces, and a plurality of sample images, which are known to not be of faces.

The orientation of the faces within photographs S0 to be processed by the characteristic extracting portion 1 is unknown. Therefore, the sample images employed for generating the first reference data E1 have the following specifications. That is, the sample images are of a 30×30 pixel size, the distances between the centers of the eyes of each face within the images are one of 9, 10, or 11 pixels, and the faces are rotated stepwise in three degree increments within a range of ±15 degrees from the vertical (that is, the rotational angles are −15 degrees, −12 degrees, −9 degrees, −6 degrees, 0 degrees, 3 degrees, 6 degrees, 9 degrees, 12 degrees, and 15 degrees). Accordingly, 33 sample images (3×11) are prepared for each face. Generating the first reference data E1 using these sample images enable discrimination of faces which are tilted, such as those illustrated in FIGS. 11B and 11C. On the other hand, the eye detecting portion 10 detects faces from the extraction range images S0a, which are obtained by the face detection range obtaining portion 11. The extraction range images S0a are rotated such that the orientation of the faces therein is vertical, as in the image of FIG. 11A. Therefore, the first reference data E1a can be generated, employing only the three topmost sample images illustrated in FIG. 9 for each face.

Note that the technique for learning the first reference data E1a and the second reference data E2 is the same as the technique for learning the first reference data E1, employed by the characteristic extracting portion 1. Therefore, a detailed description thereof will be omitted.

The sample images, which are employed during generation of the second reference data E2 and are known to be of faces, have the following specifications. That is, the sample images are of a 30×30 pixel size, the distances between the centers of the eyes of each face within the images are one of 9.7, 10, or 10.3 pixels, and the faces are vertically oriented (the rotational angle is 0 degrees) at the center point between the two eyes. Note that sample images in which the distances between the centers of the eyes are 10 pixels may be enlarged/reduced by magnification rates of 9.7 or 10.3 in order to obtain sample images in which the distances between the centers of the eyes are 9.7 and 10.3 pixels, then the enlarged/reduced sample images may be resized to 30×30 pixels.

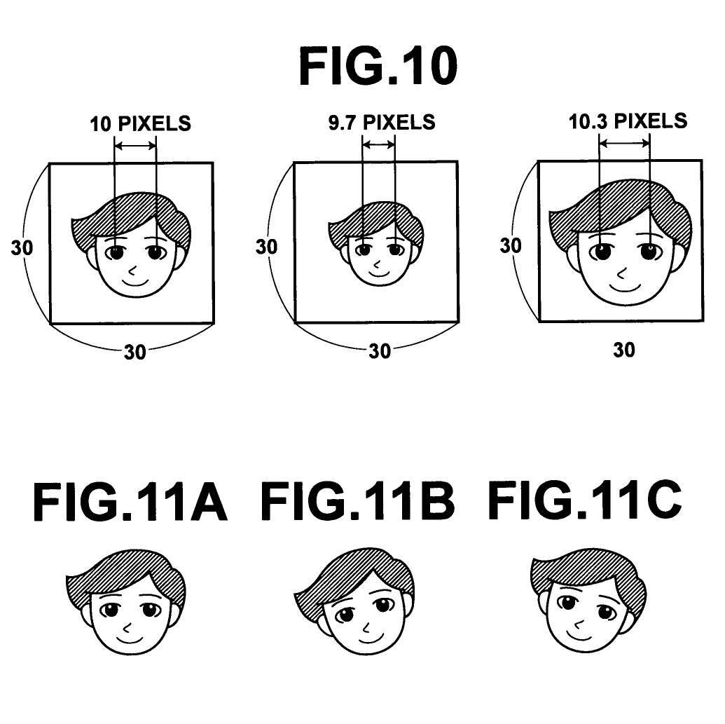

Generally, faces that are possibly included in photographs are not only those which have planar rotational angles of 0 degrees, such as that illustrated in FIG. 11A. There are cases in which the faces are rotated, as illustrated in FIGS. 11B and 11C. For this reason, in the case that learning is performed using only sample images in which the rotational angle of faces is 0 degrees, eyes cannot be discriminated from within image of faces which are rotated, such as those illustrated in FIGS. 11B and 11C. In order to enable discrimination of eyes from faces which have been rotated, it is necessary to employ sample images which hare rotated stepwise in one degree increments. In the present embodiment, however, the extraction range images S0a obtained by the face detection range obtaining portion 11 are images in which the rotational angle of the faces therein is 0 degrees. Therefore, the facial images extracted therefrom by the first discriminating portion 14 also include faces, of which the rotational angle is 0 degrees. Accordingly, the sample images employed in the detection of the eyes may only be those in which faces are not rotated, as illustrated in FIG. 10.

Note that the central positions of the eyes in the sample images, which are employed in the learning of the second reference data E2, are the positions of the eyes to be discriminated in the present embodiment.

Arbitrary images of a 30×30 pixel size are employed as the sample images which are known to not be of faces.

The first discriminating portion 14 refers to the discrimination conditions of the first reference data E1a, which has been learned regarding every combination of the characteristic amounts C0 of each pixel that constitutes a plurality of types of pixel groups. Thereby, the discrimination points of the combinations of the characteristic amounts C0 of each pixel that constitutes each of the pixel groups are obtained. Faces within the extraction range image S0a are discriminated by totaling the discrimination points. At this time, the directions of the gradient vectors K are quaternarized, and the magnitudes thereof are ternarized.

Here, the extraction range images S0a are extracted by the characteristic extracting portion 1 and therefore their sizes are varied, unlike the sample images, which are 30×30 pixels. For this reason, the first discriminating portion 14 enlarges/reduces the extraction range image S0a in a stepwise manner until the size thereof becomes 30 pixels in either the vertical or horizontal direction. A mask M, which is 30×30 pixels large, is set on the extraction range image S0a, at every stepwise increment of the enlargement/reduction. The mask M is moved one pixel at a time on the extraction range image S0, and whether the image within the mask is that of a face is discriminated.

Note that during learning of the first reference data E1a, sample images are utilized, in which the distances between the centers of the eyes are one of 9, 10, and 11 pixels. Therefore, the magnification rate during enlargement/reduction of the target image S0 and of the candidate may be set to be 11/9.

Here, the characteristic amount calculating means 12 calculates the characteristic amounts C0 at each step of enlargement/reduction deformation of the extraction range image S0a.

Here, the photographs S0, which are the subject of processing by the characteristic extracting portion 1, differ from the sample images in that they are of various sizes, and not 30×30 pixels. In addition, in the case that faces are included in the photographs S0, the planar rotational angle thereof may not necessarily be 0 degrees. For this reason, the discriminating portion 5 of the characteristic extracting portion 1 enlarges/reduces the photograph S0 in a stepwise manner until the size thereof becomes 30 pixels in either the vertical or horizontal direction. At the same time, the photograph is rotated 360 degrees in a stepwise manner. A mask M, which is 30×30 pixels large, is set on the enlarged/reduced photograph S0, at every stepwise increment of the rotation. The mask M is moved one pixel at a time on the photograph S0, and faces which are included in the photograph S0 are discriminated, by discriminating whether the image within the mask is that of a face. On the other hand, the extraction range images S0a, which are the subject of processing by the eye detecting portion 10, include faces which have rotational angles of 0 degrees. Therefore, the first discriminating portion 14 of the eye detecting portion 10 enlarges/reduces the extraction range image S0a until the size thereof becomes 30 pixels in either the vertical or horizontal direction. A mask M, which is 30×30 pixels large, is set on the enlarged/reduced extraction range image S0a, at every stepwise increment of the enlargement/reduction. The mask M is moved one pixel at a time on the extraction range image S0a, and faces which are included in the extraction range image S0a are discriminated, by discriminating whether the image within the mask is that of a face. That is, because the rotational angle of the faces within the extraction range images S0a is 0 degrees, it is not necessary to rotate the extraction range image S0a, although enlargement/reduction is performed. Therefore, the amount of calculations is reduced compared to that performed by the discriminating portion 5 of the characteristic extracting portion 1, which is efficient.

In addition, the images, to which the facial discrimination process is administered by the first discriminating portion 14, are the extraction range images S0a, which are only portions of the photographs S0. Therefore, the range in which discrimination is performed is narrower. Accordingly, the amount of calculations can be further reduced, compared to the case in which faces are discriminated from within the entire photographs S0.

As described previously, the discriminating portion 5 of the characteristic extracting portion 1 discriminates faces within the photographs S0, by judging that faces are included when discrimination points are greater than or equal to the predetermined facial discrimination threshold value. The photographs S0 include background portions other than the faces. The predetermined facial discrimination threshold value is employed to discriminate faces to prevent false positive discrimination. That is, the predetermined facial discrimination threshold value is employed so that portions of the photographs S0 other than faces are not discriminated as faces. On the other hand, the first discriminating portion 14 of the eye detecting portion 10 discriminates faces within extraction range images S0a, which include faces as main subjects therein, and have little background portions. Therefore, discrimination is performed based on whether the sum of all of the discrimination points is positive or negative. For example, in the case that the total sum of the discrimination points is negative, it is judged that a face is not included in the mask M. On the other hand, a 30×30 pixel area corresponding to the mask M is extracted as a facial image, from the extraction range image S0a at the step of deformation, at which the total positive sum of the discrimination points within the 30×30 pixel size mask M is the greatest.

The second discriminating portion 15 refers to the discrimination conditions of the second reference data E2, which has been learned regarding every combination of the characteristic amounts C0 of each pixel that constitutes a plurality of types of pixel groups, d of the facial images, extracted by the first discriminating portion 14. Thereby, the discrimination points of the combinations of the characteristic amounts C0 of each pixel that constitutes each of the pixel groups are obtained. The positions of the eyes are discriminated by totaling the discrimination points. The characteristic amounts C0 are the directions and the magnitudes of the gradient vectors K. At this time, the directions of the gradient vectors K are quaternarized, and the magnitudes thereof are ternarized.

Here, the second discriminating portion 15 deforms the facial images extracted by the first discriminating portion 14 by stepwise enlargement/reduction. A mask M, which is 30×30 pixels large, is set on the facial image, at every stepwise increment of the enlargement/reduction. The mask M is moved one pixel at a time on the facial image, and the positions of eyes within the image within the mask M is discriminated.

Here, the second discriminating portion 15 processes facial images, in which the rotational angle of the faces is 0 degrees. Therefore, it is not necessary to rotate the facial images, although enlargement/reduction is performed, similar to the case in which the first discriminating portion 14 discriminates the faces within the extraction range images S0a. Accordingly, the amount of calculations is reduced, which is efficient.

Note that during learning of the second reference data E2, sample images are utilized, in which the distances between the centers of the eyes are one of 9.7, 10, and 10.3 pixels. Therefore, the magnification rate during enlargement/reduction of the target image S0 and of the candidate may be set to be 10.3/9.7.

The characteristic amount calculating means 12 calculates the characteristic amounts C0 at each step in the stepwise enlargement/reduction of the facial image.

In the present embodiment, the discrimination points are added at each step in the stepwise deformation of the extracted facial image. The step of deformation at which the total sum of the discrimination points within the 30×30 pixel size mask M is the greatest is determined. The upper left corner of the facial image within the mask M is set as the origin of a coordinate system. The coordinates of the positions of the eyes (x1, y1) and (x2, y2) are obtained, and positions corresponding to these coordinates in the target image, prior to deformation thereof, are discriminated as the positions of the eyes.

The second discriminating portion 15 obtains distances D between the eyes from the positions thereof, discriminated by the process described above. The positions of the eyes and the distances D therebetween are output to the pupil center position detecting portion 50, as data Q.

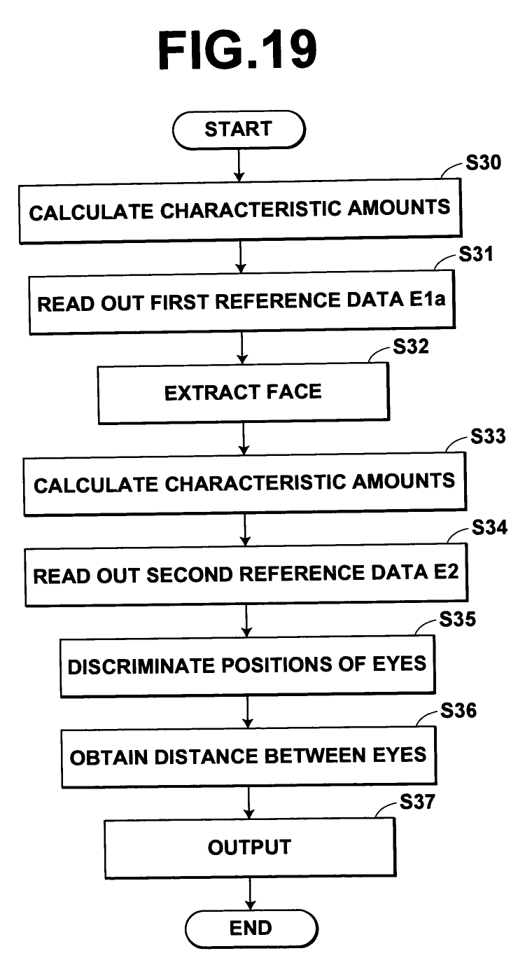

FIG. 19 is a flow chart that illustrates the processes performed by the eye detecting portion 10. First, the characteristic amount calculating portion 12 calculates the directions and magnitudes of gradient vectors K within the extraction range image S0a as characteristic amounts C0, at each step of enlargement/reduction thereof (step S30). Then, the first discriminating portion 14 reads out the first reference data E1a from the third memory 13 (step S31). A face included in the extraction range image S0a is discriminated, and the discriminated face is extracted as a facial image (step S32). Next, the characteristic amount calculating portion 12 calculates the directions and magnitudes of gradient vectors K within the facial image as characteristic amounts C0, at each step of enlargement/reduction thereof (step S33). The second discriminating portion 15 reads out the second reference data E2 from the third memory 13 (step S34). The positions of the eyes included in the face are discriminated (step S35).

Thereafter, the second discriminating portion 15 determines the distance D between the two eyes, based on the positions thereof discriminated in step S35 (step S36). The second discriminating portion 15 outputs the positions of the eyes and the distance D therebetween to the pupil center position detecting portion 50, as data Q (step S37).

Next, the pupil center position detecting portion 50 will be described.

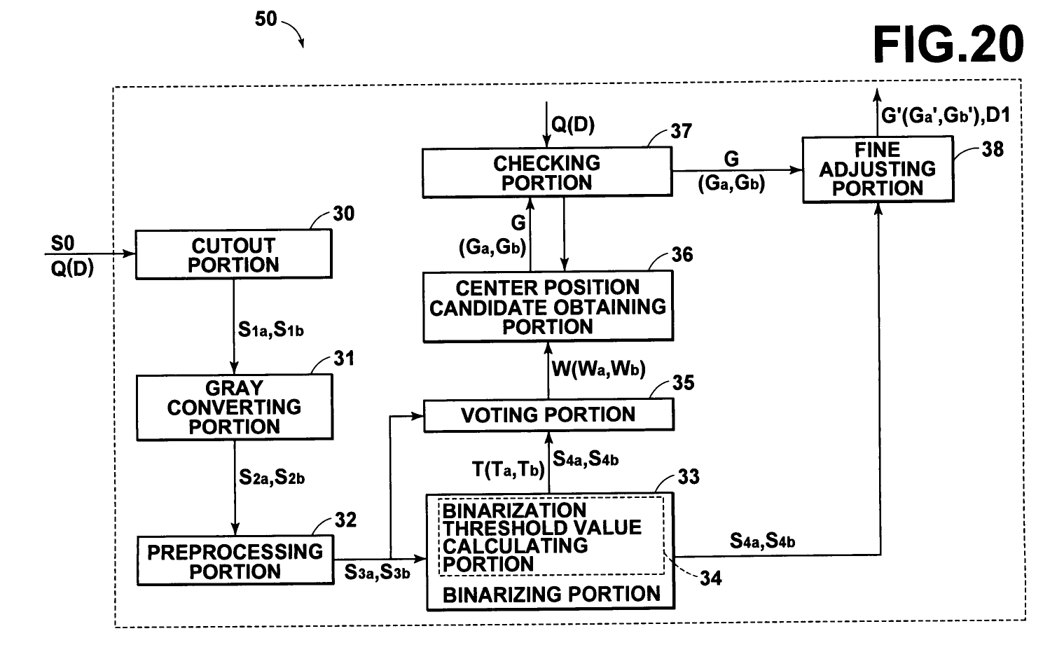

FIG. 20 is a block diagram that illustrates the configuration of the pupil center position detecting portion 50. As illustrated in FIG. 20, the pupil center position detecting portion 50 comprises: a cutout portion 30, for dividing photographs S0 into two single eye images S1a and S1b (hereinafter, collectively referred to as “single eye images S1”, if distinct descriptions thereof are not necessary), which include the left eye and the right eye, respectively, based on the data Q from the eye detecting portion; a gray converting portion 31, for administering gray conversion on the single eye images S1 to obtain gray scale images S2 (S2a and S2b); a preprocessing portion 32, for administering preprocesses on the gray scale images S2 to obtain preprocessed images S3 (S3a and S3b); a binarization threshold value calculating portion 34, for calculating threshold values T, which are employed to binarize the preprocessed images S3; a binarizing portion 33, for administering binarization processes on the preprocessed images S3 to obtain binarized images S4 (S4a and S4b); a voting portion 35, for voting the coordinates of each pixel of the binarized images S4 into a Hough space for circles to obtain poll values of each voting position, and for calculating total poll values W (Wa and Wb) for voting positions having the same coordinates for the centers of the circles; a center position candidate obtaining portion 36, for designating the coordinates having the greatest total poll value W as center position candidates G (Ga and Gb), and for searching for a next center position candidate when commanded by a checking portion 37, to be described later; the checking portion 37, for judging whether the center position candidates G obtained by the center position candidate obtaining portion 36 satisfy checking criteria, outputting the center position candidates G to a fine adjusting portion 38, to be described later, if they satisfy the checking criteria, and commanding the center position candidate obtaining portion 36 to search for new center position candidates if they do not satisfy the checking criteria repeatedly until the center position candidates G obtained by the center position candidate obtaining portion 36 satisfy the checking criteria; and the fine adjusting portion 38, for performing fine adjustments on the center positions G (Ga and Gb) of the pupils output from the checking portion 37, to obtain final center positions G′ (G′a and G′b) and determining the distance D1 between the two pupils.

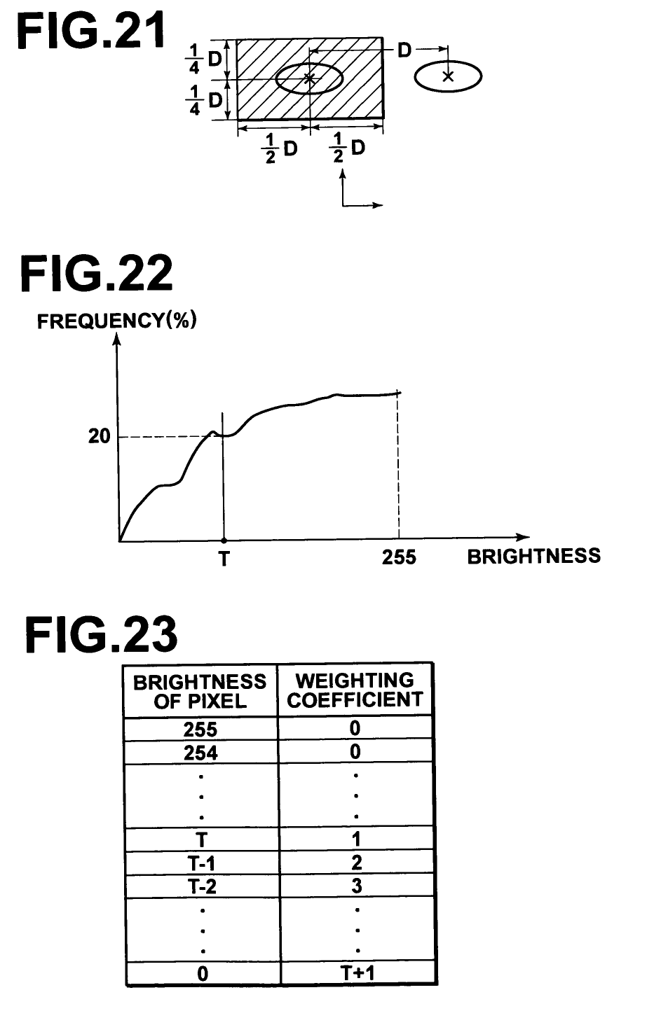

The cutout portion 30 trims the image to leave predetermined areas, each including only a left eye or a right eye, based on the information Q, which is output from the eye detecting portion 10. Thereby, the single eye images S1a and S1b are obtained. Here, the predetermined areas to be trimmed are the areas, each surrounded by an outer frame, which corresponds to the vicinity of each eye. For example, the predetermined area may be a rectangular area, which has a size of D in the x direction and 0.5D in the y direction, with its center at the position (center position) of the eye detected by the eye detecting portion 10, as illustrated by the hatched area in FIG. 21. The hatched area, which is illustrated in FIG. 21, is the trimming range of the left eye. The trimming range of the right eye is obtained in a similar manner.

The gray converting portion 31 administers gray conversion processing on the single eye images S1, which are obtained by the cutout portion 30, according to the following equation (1), and obtains the gray scale images S2.
Y=0.299×R+0.587×G+0.114×B (1)

Note that Y: brightness value
R, G, B: R, G and B values

The preprocessing portion 32 administers preprocesses on the gray scale images S2. Here, a smoothing process and a hole-filling process are performed as the preprocesses. The smoothing process may be administered by applying a Gaussian filter, for example. An interpolation process may be administered as the hole-filling process.

As illustrated in FIGS. 18A and 18B, there is a tendency for bright spots to appear in the part of a pupil above the center of the pupil, in photographs. Therefore, the center position of the pupil can be detected more accurately by interpolating data in this part by performing the hole-filling process.

The binarizing portion 33 comprises the binarization threshold value calculating portion 34. The binarizing portion 33 binarizes the preprocessed images S3, which are obtained by the preprocessing portion 32, by using the threshold value T, which is calculated by the binarization threshold value calculating portion 34, and obtains binarized images S4. Specifically, the binarization threshold value calculating portion 34 generates a histogram of the brightness of the preprocessed images S3, which is illustrated in FIG. 22. The binarization threshold value calculating portion 34 obtains a brightness value corresponding to the frequency of occurrence, which is a fraction of the total number (⅕ or 20% in FIG. 22) of pixels in the preprocessed images S3, as the threshold value T for binarization. The binarizing portion 33 binarizes the preprocessed images S3 by using the threshold value T, and obtains the binarized images S4.

The voting portion 35 causes the coordinate of each pixel (of which the pixel value is 1) in the binarized images S4 to vote for a point in the Hough space for circles (X coordinate of the center of the circle, Y coordinate of the center of the circle, and a radius r), and calculates poll values for each voting position. Normally, if a pixel votes for a single voting position, the poll value is increased by 1, by judging that the voting position has been voted for once. Accordingly, poll values for each voting position are obtained. Here, however, when a pixel votes for a voting position, the poll value is not increased by 1. The voting portion 35 refers to the brightness value of the pixel, which has voted. The voting portion 35 weights the vote greater as the brightness value of the pixel is smaller, and adds the weighted vote to the poll values of the voting positions. FIG. 23 is a weighting coefficient table, which is used by the voting portion 35 of the pupil center position detecting portion 50 according to the present embodiment. In FIG. 23, T denotes a threshold value T for binarization, which is calculated by the binarization threshold value calculating portion 34.

After the voting portion 35 obtains the poll values for each voting position as described above, the voting portion 35 adds the poll value at each of the voting positions, of which coordinates of the center of circles, that is, the (X, Y) coordinates in the Hough space for circles (X, Y, r), are the same. Accordingly, the voting portion 35 obtains total poll values W corresponding to each (X, Y) coordinate value. The voting portion 35 outputs the obtained total poll values W to the center position candidate obtaining portion 36 by correlating the total poll values W with the corresponding (X, Y) coordinates.

The center position candidate obtaining portion 36 obtains the (X, Y) coordinates that correspond to the largest total poll values W, as the center position candidates G, based on each total poll value W, which is received from the voting portion 35. The center position candidate obtaining portion 36 outputs the obtained coordinates to the checking portion 37. Here, the center position candidates G, which are obtained by the center position obtainment unit 35, are the center position Ga of the left pupil and the center position Gb of the right pupil. The checking portion 37 checks the two center positions Ga and Gb, based on the distance D between both eyes, which is output from the eye detecting portion 10.

Specifically, the checking portion 37 checks the two center positions Ga and Gb based on the following two checking criteria.

1. The difference in the Y coordinates between the center position of the left pupil and the center position of the right pupil is less than or equal to D/50.

2. The difference in the X coordinates between the center position of the left pupil and the center position of the right pupil is within a range from 0.8×D to 1.2×D.

The checking portion 37 judges whether the center position candidates Ga and Gb of the two pupils, which are received from the center position candidate obtaining portion 36, satisfy the two checking criteria as described above. If the two criteria are satisfied (hereinafter, referred to as “satisfying the checking criteria”), the checking portion 37 outputs the center position candidates Ga and Gb to the fine adjusting portion 38 as the center positions of the pupils. On the other hand, if one or both of the criteria are not satisfied (hereinafter, referred to as “not satisfying the checking criteria”), the checking portion 37 instructs the center position candidate obtaining portion 36 to obtain the next center position candidates. The checking portion 37 also performs checking on the next center position candidates, which are obtained by the center position candidate obtaining portion 36, as described above. If the checking criteria are satisfied, the checking portion 37 outputs the center positions. If the checking criteria are not satisfied, the checking portion 37 performs processes, such as instructing the center position candidate obtaining portion 36 to obtain center position candidates again. The processes are repeated until the checking criteria are satisfied.

Meanwhile, if the checking portion 37 instructs the center position candidate obtaining portion 36 to obtain the next center position candidates, the center position candidate obtaining portion 36 fixes the center position of an eye (left pupil in this case) first, and obtains the (X, Y) coordinates of a voting position that satisfies the following three conditions, as the next center position candidate, based on each total poll value Wb of the other eye (right pupil in this case).

1. The coordinate value is away from the position represented by the (X, Y) coordinates of the center position candidate, which was output to the checking portion 37 last time, by D/30 or more (D: distance between the eyes).

2. A corresponding total poll value is the next largest total poll value to a total poll value, which corresponds to the (X, Y) coordinates of the center position candidate, which was output to the checking portion 37 last time, among the total poll values, which correspond to the (X, Y) coordinates, which satisfy condition 1.

3. The corresponding total poll value is greater than or equal to 10% of the total poll value (the greatest total poll value), which corresponds to the coordinate value (X, Y) of the center position candidate, which was output to the checking portion 37 the first time.

The center position candidate obtaining portion 36 first fixes the center position of a left pupil and searches for the center position candidate of a right pupil that satisfies the three conditions as described above, based on a total poll value Wb, which has been obtained for the right pupil. If the center position candidate obtaining portion 36 does not find any candidate that satisfies the three conditions as described above, the center position candidate obtaining portion 36 fixes the center position of the right pupil and searches for the center position of the left pupil that satisfies the three conditions as described above, based on the total poll value Wa, which has been obtained for the left pupil.

The fine adjusting portion 38 performs fine adjustment on the center positions G of the pupils (the center position candidates that satisfy the checking criteria), which are output from the checking portion 37. First, fine adjustment of the center position of the left pupil will be described. The fine adjusting portion 38 performs three mask operations on a binarized image S4a of a single eye image S1a of a left eye, which is obtained by the binarizing portion 33. The fine adjusting portion 38 uses a mask of all 1's, which has a size of 9×9. The fine adjusting portion 38 performs fine adjustment on the center position Ga of the left pupil, which is output from the checking portion 37, based on the position (called Gm) of the pixel, which has the maximum result value obtained by the mask operation. Specifically, a position having coordinates, which are averages of the coordinates of the position Gm and the center position Ga, may be designated as the final center position G′a of the pupil, for example. Alternatively, a position having coordinates, obtained by weighting coordinates of the center position Ga and performing an averaging operation, may be designated as the final center position G′a of the pupil. Here, it is assumed that the center position Ga is weighted to perform the averaging operation.

Fine adjustment of the center position of the right pupil is performed by using a binarized image S4b of a single eye image S1b of the right eye, in the same manner as described above.

The fine adjusting portion 38 performs fine adjustment on the center positions Ga and Gb of the pupils, which are output from the checking portion 37, and obtains the final center positions G′a and G′b. Then, the fine adjusting portion 38 obtains the distance D1 between the two pupils by using the final center positions G′. Then, the fine adjusting portion 38 outputs the distance D1 and the final center positions G′ to the trimming area obtaining portion 60.

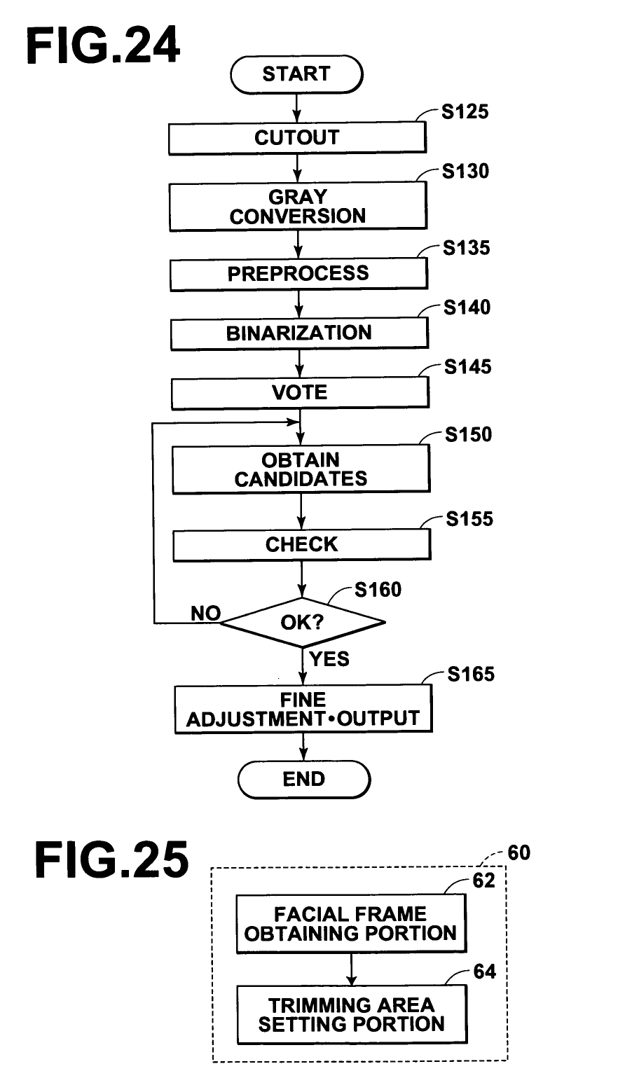

FIG. 24 is a flow chart that illustrates the processes performed by the pupil center position detecting portion 50. As illustrated in FIG. 24, first, the cutout portion 30 trims two single eye images from the photograph S0, based on the positions of the eyes and the distance D therebetween, output thereto from the eye detecting portion 10 as data Q, to obtain a single eye image S1a that includes the left eye, and a single eye image S1b that includes the right eye (step S125). The gray converting portion 31 performs gray conversion on the single eye images S1 to convert the single eye images S1 to gray scale images S2 (step S130). Then, the preprocessing portion 32 administers smoothing processes and hole-filling processes on the gray scale images S2 (step S135). Further, the binarizing portion 33 administers binarization processes on the gray scale images S2, to convert the gray scale images S2 into binarized images S4 (step S140). The voting portion 35 causes the coordinates of each pixel in the binarized images S4 to vote in the Hough space for circles. Consequently, total poll values W are obtained, corresponding to the (X, Y) coordinates representing the center of each circle (step S145). The center position candidate obtaining portion 36 first outputs the (X, Y) coordinates corresponding to the greatest total poll values to the checking portion 37 as the center position candidates G (step S150). The checking portion 37 checks the two center position candidates Ga and Gb, which are output from the center position candidate obtaining portion 36, based on checking criteria as described above (step S155). If the two center position candidates Ga and Gb satisfy the checking criteria (step S160: YES), the checking portion 37 outputs the two center position candidates Ga and Gb to the fine adjusting portion 38 as the center positions. If the two center position candidates Ga and Gb do not satisfy the checking criteria (step S160: NO), the checking portion 37 instructs the center position candidate obtaining portion 36 to search for the next center position candidates (step S150). The checking portion 37 repeats the processes from step S150 through step S160 until the checking portion 37 judges that the center position candidates G, which are output from the center position candidate obtaining portion 36, satisfy the checking criteria.

The fine adjusting portion 38 performs fine adjustment on the center positions G, which are output by the checking portion 37. The fine adjusting portion 38 obtains the distance D1 between the two pupils based on the final center positions G′. Then, the final positions G′ and the distance D1 are output to the trimming area obtaining portion 60 (step S165).

FIG. 25 is a block diagram that illustrates the configuration of the trimming area obtaining portion 60. As illustrated in FIG. 25, the trimming area obtaining portion 60 comprises: a facial frame obtaining portion 62; and a trimming area setting portion 64. The facial frame obtaining portion 62 obtains values L1a, L1b and L1c according to equations (2), by using the distance D1 between both pupils in a photograph S0 and coefficients U1a, U1b and U1c. Then, the facial frame obtaining portion 62 obtains a facial frame by using each of values L1a, L1b and L1c as the lateral width of the facial frame with its middle in the lateral direction at the middle position Pm between both eyes in the photograph S0, the distance from a middle position Gm between the pupils to the upper edge of the facial frame, and the distance from the middle position Pm to the lower edge of the facial frame, respectively. The coefficients U1a, U1b and U1c are stored in the first memory 65. In the present embodiment, the coefficients are 3.250×(1±0.05), 1.905×(1±0.05) and 2.170×(1±0.05), respectively.
L1a=D1×U1a
L1b=D1×U1b
L1c=D1×U1c (2)
Wherein:

L1a is the width of the facial frame having the middle position between the pupils as its center;

L1b is the distance from the middle position between the pupils and the upper edge of the facial frame; and

L1c is the distance from the middle position between the pupils and the lower edge of the facial frame.

The trimming area setting portion 64 sets a trimming area in the photograph S0, based on the position and the size of the facial frame, which is obtained by the facial frame obtaining portion 62, so that the trimming image satisfies the predetermined output. The trimming area is output to the trimming portion 70.

The trimming portion 70 trims the trimming area obtained by the trimming area obtaining portion 60 from the photograph S0. The trimming portion 70 also performs enlargement/reduction processes as necessary, and obtains a trimmed image.

The card generating portion 240 prints the trimmed images obtained by the trimming processing portion 100 onto employee ID's.

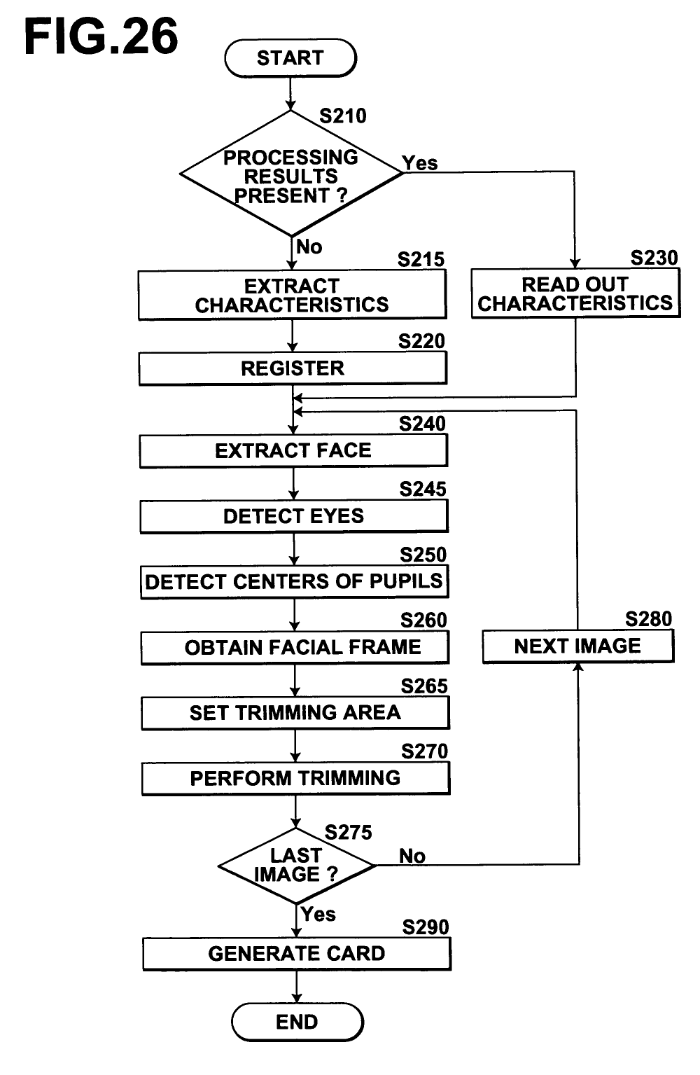

FIG. 26 is a flow chart that illustrates the processes performed at the ID card production center 300 of the ID card issuing system illustrated in FIG. 1. Note that the image storing portion 220 stores images transmitted thereto from each of the photography points, classified according to the photography point. Here, a description of the processes performed by the image storing portion 220 will be omitted. A case will be described in which photographs obtained at photography point A are already stored in the image storing portion.

As illustrated in FIG. 26, when generating employee ID's based on photographs included within a single image group (image group A, for example), first, the control portion 3 of the trimming processing portion 100 confirms whether data corresponding to the photography point at which the photographs were obtained (photography point A in this case) is present in the processing result database 6 (step S210) . If data corresponding to photography point A, that is, data that indicates the facial area and the orientation of the faces within the photographs, is present in the processing result database 6 (step S210: YES), the control portion reads out the data that indicates these characteristics and outputs the data to the eye detecting portion 10 (step S230). On the other hand, if the data is not present (step S210: NO), the first ten photographs included in image group A are output to the characteristic extracting portion 1, and the characteristics of image group A, that is, photography point A, are extracted (step S215). The characteristic extracting portion 1 discriminates faces in each of the ten photographs, to obtain the facial area and the orientation of the faces therein. Thereby, the area in which faces are present and the orientation of the faces within the ten photographs are obtained as characteristics of image group A. The characteristic extracting portion 1 outputs the characteristics of image group A to the eye detecting portion 10 (step S215), and also registers the characteristics in the processing result database 6, correlated to photography point A (step S220).

The eye detecting portion 10 detects eyes (in the present embodiment, the center positions of the eyes are discriminated) within each of the photographs of image group A, based on the characteristics of image group A output from the characteristic extracting portion 1 (steps S240 and S245). Specifically, first, the facial area, which is included in the characteristics of image group A, is obtained as the area from which faces are to be detected. Then, faces are discriminated within the facial area, to detect facial images (step S240). Note that during discrimination of faces, the area from which faces are to be detected is rotated such that the faces therein become vertical, based on the orientation of the faces, which is also included in the characteristics of image group A. By determining the area from which faces are to be detected and the orientation of the faces in this manner, the process is made more efficient. Next, eyes are discriminated from within the extracted facial images, to obtain the center positions of the eyes and the distances D therebetween.

The pupil center position detecting portion 50 utilizes data Q, which comprises the center positions of the eyes and the distances D therebetween, obtained by the eye detecting portion 10, to detect the center positions of the pupils within the photographs and the distances D1 therebetween (step S250).

The trimming area obtaining portion 60 obtains the facial frames employing the center positions of the pupils and the distances D1 therebetween (step S260), and sets the trimming area based on the facial frame (step S265).

The trimming portion 70 trims images corresponding to the trimming area set by the trimming area obtaining portion 60 from the photographs, performs enlargement/reduction processes as necessary, and obtains trimmed images (step S270).

The trimming processing portion 100 performs the processes from the extraction of faces (step S240) based on the characteristics of image group A, to the obtainment of trimmed images (step S270) on all of the photographs included in image group A, to obtain trimmed images thereof (step S275: NO, step S280, steps S240 through S270).

The card generating portion 240 prints each of the trimmed images obtained by the trimming processing portion 100, to generate employee ID's (step S290).

Note that here, the card generating portion 240 initiates generation of cards after trimmed images are obtained for all of the photographs included in image group A by the trimming processing portion 100. However, the trimming processing portion 100 may output trimmed images to the card generating portion 240 as soon as they are obtained. In this case, the card generating portion 240 may generate employee ID's sequentially, employing the trimmed images output thereto form the trimming processing portion 100.

In addition, the eye detecting portion 10 performs detection of the face by determining the facial area, extracted as a characteristic, during detection of the eyes, based on the characteristics extracted from the first ten photographs of the image group. The detection of the face is performed on all of the photographs included in the image group (including the first ten photographs). However, faces have already been detected from within the first ten photographs during extraction of the characteristics. Therefore, regarding the first ten photographs, detection of the eyes may be performed on the faces extracted during characteristic extraction, without the eye detecting portion 10 performing facial detection again.

In this manner, the ID card issuing system of the present embodiment administers trimming processes on photographs obtained at a plurality of photography points, which have different photography conditions from each other. The ID card issuing system notes that photographs obtained at the same photography point have substantially the same facial areas and orientations of faces therein. Therefore, faces are discriminated from within a portion of the photographs included in an image group (the first ten photographs in the present embodiment), and the facial areas and orientations of the faces therein are extracted as characteristics of the image group. Areas, from within which faces are to be detected, and the orientations of the faces to be detected are determined, based on the extracted characteristics. Then, detection of the faces and detection of eyes, which are necessary in setting trimming areas, are performed. By determining the area, from within which faces are to be detected, and the orientations of the faces to be detected, the amount of calculations is reduced. Accordingly, the trimming process can be performed efficiently.

A preferred embodiment of the present invention has been described above. However, the method, apparatus, and program for trimming images are not limited to the above embodiment. Various changes and modifications may be applied, so long as they are within the scope of the present invention.

For example, in the present embodiment, the facial area (the position and size of the face) and the orientation of the faces are extracted as the characteristics of the image group. However, any one or a combination of the position of the face (or a range of positions of the face), the size, and the orientation thereof may be extracted as the characteristics. Further, the characteristics of the image group are not limited to the facial area and the orientation of faces, but may be any characteristics which are necessary during trimming processes.

The present embodiment determines the area, from within which faces are to be detected, and the orientation of the faces by employing the characteristics. However, for example, the faces may be detected by determining the size of faces to be detected, employing only the size of the faces. Specifically, in the present embodiment, the eye detecting portion 10 may utilize the size of faces included in the facial area, obtained as a characteristic by the characteristic extracting portion during detection of faces. That is, the size of faces to be detected may be determined during detection by the first discriminating portion 14 and the second discriminating portion 15. In this case, the magnification ratio employed during the stepwise enlargement/reduction illustrated in FIG. 14 may be determined as the magnification ratio corresponding to the size of the face, during detection of the faces. By adopting this configuration, the amount of calculations is reduced. Accordingly, the process becomes more efficient.

In the present embodiment, the orientation of faces is extracted as a characteristic of an image group, and only faces having the characteristic orientation are detected during detection of faces from within photographs included in the image group. Alternatively, for example, predetermined ranges for orientations that include the orientation of the faces extracted as a characteristic of an image group may be determined. In this case, the predetermined range may be determined as the range of orientations of faces to be detected during detection of faces from within photographs included in the image group, and faces having orientations within this range may be detected.

In the present embodiment, the first data E1a, which is recorded in the second memory 4, is learned by employing sample images, in which faces are rotated within a range of −15 to 15 degrees in three degree increments (that is, faces having rotational angles of −15 degrees, −12 degrees, −9 degrees, −6 degrees, −3 degrees, 0 degrees, 3 degrees, 6 degrees, 9 degrees, 12 degrees, and 15 degrees). In addition, the photographs are rotated in 30 degree increments during detection of the faces. This configuration is adopted to enable detection of faces having any orientation (−180 degrees to 180 degrees) within the photographs. However, in the case of the system of the present embodiment, in which ID photos are obtained to generate employee ID's and the like, the orientations of the faces, that is, the camera angle at each photography point can be assumed to be one of 0 degrees, 90 degrees, 180 degrees, −180 degrees, and −90 degrees. In cases like these, when the orientation of faces is extracted as a characteristic, the extraction need not be performed over the entire range of −180 degrees to 180 degrees. Instead, the orientation of the faces can be extracted from among the possible orientations, for example, the aforementioned 0 degrees, 90 degrees, 180 degrees, −180 degrees, and −90 degrees. That is, in the present embodiment, the characteristic extracting portion 1 may obtain reference data by learning employing only sample images, which are known to be of faces, having rotational angles of 0 degrees. When employing the reference data to obtain the orientation of faces, the photographs may be rotated in 90 degree increments during detection of the faces therein. Alternatively, reference data may be obtained by learning employing sample images, which are known to be of faces, having rotational angles of 0 degrees, 90 degrees, 180 degrees, −180 degrees, and −90 degrees. In this case, the orientation of the faces can be obtained by detecting the faces without rotating the photographs, by employing the reference data.

The processes up to obtainment of the trimmed images are performed on the first ten photographs of an image group, to obtain the characteristics thereof. The magnification ratio, employed by the trimming portion 70 to enlarge/reduce trimming areas obtained by the trimming area obtaining portion 60 so that the trimmed images satisfy a predetermined format, may also be recorded as a characteristic of the image group. The magnification ratio is related to the size of the photographs, and may be different for each photography point. In this case, during trimming processes administered to other photographs within the image group, enlargement/reduction of the trimming areas thereof maybe performed by applying the magnification ratio, which was extracted as a characteristic.

In the present embodiment, faces are detected to obtain the facial area and the orientation of faces, during extraction of characteristics of an image group by the characteristic extracting portion 1. Alternatively, the first ten photographs of an image group, for example, may be displayed and confirmed by an operator. Then, the operator may input the facial area and the orientation of faces.

In the present embodiment, characteristics of photography points, from which photographs have been processed once, are registered. Alternatively, a database, in which characteristics of each photography point are registered in advance, may be provided. In this case, characteristics corresponding to a photography point may be read out, based on the photography point of an image group, during processing of the image group.

The data that indicates the photography points of image groups is not limited to that which is attached to the photographs. Alternatively, an operator may input the photography points.

In the present embodiment, the eye detecting portion 10 calculates discrimination points within facial area images, and detects as faces those facial areas in which the discrimination points are positive and have the greatest absolute values. Alternatively, faces may be detected if the discrimination points are equal to or greater than a facial discrimination threshold value, in the same manner as in the characteristic extracting portion 1. For photographs in which faces are not detected by employing the facial discrimination threshold value, the detection may be repeated, incrementally lowering the discrimination threshold. Alternatively, during trimming processing of an image group, processes following detection of the face may be administered on photographs, in which faces are detected, while photographs in which faces are not detected may be temporarily recorded in a memory device, such as a hard disk. Then, detection of faces may be repeated on the temporarily recorded photographs, incrementally lowering the facial discrimination threshold, after processing for all of the other photographs included in the image group are completed.

In the description of the ID card issuing system of the present embodiment, the correlation between the photographs, the trimmed images, and detailed items imprinted on the ID card (such as: name, date of birth, employment start date, division, and title) is not described for the sake of convenience. However, a database, in which employee numbers of each employee are correlated with personal data of the employee (including at least the detailed items to be imprinted on the ID card) may be provided. In this case, the employee number maybe attached to the photographs and the trimmed images as ID numbers. When the card generating portion 240 generates the employee ID's, the personal data correlated to the employee number, which is attached to the trimmed image, may be read out from the database.

In the present embodiment, the trimming area is set based on the positions of the pupils, which are detected from the photographs. Alternatively, the trimming area may be set based on the positions of the face or the positions of the eyes. As a further alternative, the trimming area may be set based on the position of the top of the head, the position of the chin, and the like.

1. A method for trimming images, comprising the steps of:
detecting a trimming area setting region, which is a facial region or a predetermined region within a facial region, for setting a trimming area that includes the facial region from a photographic image of a face, to obtain a trimmed image, which is defined as that in which the facial region is arranged at a predetermined position and at a predetermined size;
setting the trimming area within the photographic image of the face, based on the trimming area setting region, such that the trimmed image matches the above definition; and
performing cutout and/or enlargement/reduction on the trimming area, to obtain the trimmed image; wherein:
characteristics that determine processing conditions of at least one of the detecting step, the setting step, the cutout and/or enlargement/reduction steps are obtained for each of at least one image group, constituted by a plurality of photographic images of faces, which are obtained by photographing people under the same photography conditions;
the processing conditions of the above steps are determined according to the characteristics; and
the steps are performed on the photographic images of the faces employing the determined processing conditions.

2. A method for trimming images as defined in claim 1, wherein:
the photographic images of faces are those which are obtained at one of a plurality of photography points, each having different photography conditions; and
each of the image groups are constituted by photographic image of faces which are obtained at the same photography point.

3. A method for trimming images as defined in claim 1, wherein:
the characteristics of the image groups are obtained by employing a portion of the photographic images of faces included in the image groups.

4. A method for trimming images as defined in claim 1, wherein:
the characteristics include the size of the face within each of the photographic images of faces included in each of the image groups; and
the size of faces to be detected is determined based on the size of the face included in the characteristics, during detection of the trimming area setting region, which requires detection of faces.

5. A method for trimming images as defined in claim 1, wherein:
the characteristics include the position of the face within each of the photographic images of faces included in each of the image groups;
the detection range for the trimming area setting region is determined based on the position of the face included in the characteristics; and
the trimming area setting region is performed within the detection range.

6. A method for trimming images as defined in claim 1, wherein:
the characteristics include the orientation of the face in each of the photographic images of faces included in each of the image groups;
the orientation of faces to be detected is determined based on the orientation of the face included in the characteristics, during detection of the trimming area setting region, which requires detection of faces.

7. An image trimming apparatus, comprising:
a trimming area setting region detecting means, for detecting a trimming area setting region, which is a facial region or a predetermined region within a facial region, for setting a trimming area that includes the facial region from a photographic image of a face, to obtain a trimmed image, which is defined as that in which the facial region is arranged at a predetermined position and at a predetermined size;
a trimming area setting means, for setting the trimming area within the photographic image of the face, based on the trimming area setting region, such that the trimmed image matches the above definition;
a trimming means, for performing cutout and/or enlargement/reduction on the trimming area, to obtain the trimmed image; and
a characteristic obtaining means, for obtaining characteristics that determine processing conditions employed by at least one of the trimming area setting region detecting means, the trimming area setting means, and the trimming means for each of at least one image group, constituted by a plurality of photographic images of faces, which are obtained by photographing people under the same photography conditions; wherein
the processing conditions employed by at least one of the trimming area setting region detecting means, the trimming area setting means, and the trimming means are determined according to the characteristics; and
the trimming area setting region detecting means, the trimming area setting means, and the trimming means performs their respective processes on the photographic images of the faces employing the determined processing conditions.

8. An image trimming apparatus as defined in claim 7, wherein:
the photographic images of faces are those which are obtained at one of a plurality of photography points, each having different photography conditions; and
each of the image groups are constituted by photographic image of faces which are obtained at the same photography point.

9. An image trimming apparatus as defined in claim 7, wherein:
the characteristics of the image groups are obtained by employing a portion of the photographic images of faces included in the image groups.

10. An image trimming apparatus as defined in claim 7, wherein:
the characteristics include the size of the face within each of the photographic images of faces included in each of the image groups; and
the size of faces to be detected is determined based on the size of the face included in the characteristics, during detection of the trimming area setting region, which requires detection of faces.

11. An image trimming apparatus as defined in claim 7, wherein:
the characteristics include the position of the face within each of the photographic images of faces included in each of the image groups;
the detection range for the trimming area setting region is determined based on the position of the face included in the characteristics; and
the trimming area setting region is performed within the detection range.

12. An image trimming apparatus as defined in claim 7, wherein:
the characteristics include the orientation of the face in each of the photographic images of faces included in each of the image groups;
the orientation of faces to be detected is determined based on the orientation of the face included in the characteristics, during detection of the trimming area setting region, which requires detection of faces.

13. A program that causes a computer to execute a method for trimming images, comprising:
a detecting procedure, for detecting a trimming area setting region, which is a facial region or a predetermined region within a facial region, for setting a trimming area that includes the facial region from a photographic image of a face, to obtain a trimmed image, which is defined as that in which the facial region is arranged at a predetermined position and at a predetermined size;
a setting procedure, for setting the trimming area within the photographic image of the face, based on the trimming area setting region, such that the trimmed image matches the above definition; and
a trimming procedure, for performing cutout and/or enlargement/reduction on the trimming area, to obtain the trimmed image; wherein:
the computer is caused to obtain characteristics that determine processing conditions of at least one of the detecting procedure, the setting procedure, the cutout procedure and/or the enlargement/reduction procedures for each of at least one image group, constituted by a plurality of photographic images of faces, which are obtained by photographing people under the same photography conditions;
the processing conditions of the above procedures are determined according to the characteristics; and
the detecting procedure and/or the setting procedure and/or the trimming procedure are performed on the photographic images of the faces employing the determined processing conditions.

14. A computer readable medium, having the program defined in claim 13 recorded therein.
